(19) United States
(12) Patent Application Publication
(10) Pub. No.: US 2026/0319551 A1
(43) Pub. Date: Oct. 15, 2026

(54) ELECTRONIC DEVICE FOR DISPLAYING PLURALITY OF EXECUTION SCREENS RESPECTIVELY ON PORTIONS OF FLEXIBLE DISPLAY, AND METHOD THEREFOR

(71) Applicant: SAMSUNG ELECTRONICS CO., LTD., Suwon-si (KR)

(72) Inventors: Hyerim BAE, Suwon-si (KR); Huijong SHIN, Suwon-si (KR); Jaesung SHIM, Suwon-si (KR)

(21) Appl. No.: 19/704,886

(22) Filed: Jun. 11, 2026

Related U.S. Application Data
(63) Continuation of application No. PCT/KR2025/000748, filed on Jan. 13, 2025.

(30) Foreign Application Priority Data
Mar. 8, 2024 (KR) 10-2024-0033522
Apr. 1, 2024 (KR) 10-2024-0044397

(51) Int. Cl. G06F 1/16; G06F 3/04817

(52) U.S. Cl. CPC G06F 1/1677; G06F 1/1641; G06F 1/1652; G06F 3/04817; G06F 2200/1637; G06F 2203/04803

(57) ABSTRACT

An electronic device may: display, on a flexible display, a first execution screen related to a first application; display at least one icon related to at least one application in one area of the flexible display; receive an input for moving the at least one icon to a defined area of the flexible display; display a second execution screen related to the at least one application in the defined area of the flexible display based on receiving the input, and display the first execution screen related to the first application by moving the first execution screen to the left or right of the second execution screen.

### CROSS-REFERENCE TO RELATED APPLICATIONS

This application is a continuation of International Application No. PCT/KR2025/000748 designating the United States, filed on Jan. 13, 2025, in the Korean Ministry of Intellectual Property Receiving Office and claiming priority to Korean Patent Application Nos. 10-2024-0033522, filed on Mar. 8, 2024, and 10-2024-0044397, filed on Apr. 1, 2024, in the Korean Ministry of Intellectual Property, the disclosures of each of which are incorporated by reference herein in their entireties.

### BACKGROUND

### Field

The present disclosure relates to an electronic device for respectively displaying a plurality of execution screens in portions of a flexible display, and a method thereof.

### Description of Related Art

A form and/or a size of an electronic device is being diversified. In order to enhance mobility, an electronic device having a reduced size and/or a reduced volume is being designed. The electronic device may include a display for visualizing information. As the number of functions supported by the electronic device increases, a size of the display may be increased in order to visualize more information to a user and/or in order to support execution of the functions. For example, the size of the display may be designed to be maintained or increased while reducing the size and/or the volume of the electronic device.

The above-described information may be provided as a related art for the purpose of helping understanding of the present disclosure. No assertion or determination is made as to whether any of the above description may be applied as a prior art related to the present disclosure.

### SUMMARY

According to an example embodiment, an electronic device may comprise: a housing includes a first housing, a second housing rotatably coupled to the first housing, and a third housing rotatably coupled to the second housing, a flexible display disposed on a front side of the first housing, the second housing, and the third housing, memory, comprising one or more storage mediums, storing instructions, and at least one processor comprising processing circuitry, wherein the instructions, when executed by at least one processor individually or in any combination, may cause the electronic device to: display a first execution screen associated with a first application on the flexible display; display at least one icon associated with at least one application in a portion of the flexible display; to receive an input to move the at least one icon to a defined portion of the flexible display; based on receiving the input, display a second execution screen associated with the at least one application in the defined portion of the flexible display; and display the first execution screen associated with the first application by moving to a left side or a right side of the second execution screen.

According to an example embodiment, a method of operating an electronic device may be provided. The electronic device may comprise a housing including a first housing, a second housing rotatably coupled to the first housing, and a third housing rotatably coupled to the second housing, and a flexible display disposed on a front side of the first housing, the second housing, and the third housing. The method may comprise: displaying a first execution screen associated with a first application on the flexible display; displaying at least one icon associated with at least one application in a portion of the flexible display; receiving an input to move the at least one icon to a defined portion of the flexible display; based on receiving the input, displaying a second execution screen associated with the at least one application in the defined portion of the flexible display; and displaying the first execution screen associated with the first application by moving to a left side or a right side of the second execution screen.

According to an example embodiment, an electronic device may include: a housing including a first housing, a second housing rotatably coupled to the first housing part, and a third housing rotatably coupled to the second housing, a flexible display disposed on front sides of the first housing, the second housing, and the third housing, memory, comprising one or more storage mediums, storing instructions, and at least one processor comprising processing circuitry, wherein the instructions, when executed by at least one processor individually or in any combination, may cause the electronic device to: display a first execution screen on the flexible display; receive an input for dragging an icon associated with a second execution screen; based on receiving the input for dragging the icon to a first portion of the flexible display positioned on the first housing ; or a second portion of the flexible display positioned on the second housing ;, display the second execution screen in the first portion and the second portion, and display the first execution screen reduced according to a size of a third portion in the third portion of the flexible display positioned on the third housing ; and based on receiving the input for dragging the icon to the third portion of the flexible display, display the first execution screen reduced according to a size of the first portion in the first portion, and display the second execution screen in the second portion and the third portion.

According to an example embodiment, a method of an electronic device may be provided. The electronic device may comprise: a housing including a first housing, a second housing rotatably coupled to the first housing, and a third housing rotatably coupled to the second housing, and a flexible display disposed on front sides of the first housing, the second housing, and the third housing. The method may comprise: displaying a first execution screen on the flexible display; receiving an input for dragging an icon associated with a second execution screen; based on receiving the input for dragging the icon to a first portion of the flexible display positioned on the first housing or a second portion of the flexible display positioned on the second housing, displaying the second execution screen in the first portion and the second portion, and displaying the first execution screen reduced according to a size of a third portion in the third portion of the flexible display positioned on the third housing ; and based on receiving the input for dragging the icon to the third portion of the flexible display, displaying the first execution screen reduced according to a size of the first portion in the first portion, and displaying the second execution screen in the second portion and the third portion.

According to an example embodiment, a non-transitory computer readable storage medium storing instructions may be provided. The instructions, when executed by an electronic device comprising a multi-foldable housing including a first housing, a first hinge assembly, a second housing rotatably coupled to the first housing through the first hinge assembly, a second hinge assembly, and a third housing rotatably coupled to the second housing through the second hinge assembly, and a flexible display disposed on front sides of the first housing, the second housing, and the third housing, and at least one processor, comprising processing circuitry. The instructions, when executed by at least one processor of the electronic device, individually or in any combination, may cause the electronic device to: display a first execution screen in an entire displaying region of the flexible display in an unfolded state of the multi-foldable housing; receive an input for further displaying a second execution screen in the displaying region; in response to the input received while displaying the first execution screen of a first category, display the second execution screen in a first portion of the displaying region positioned on the first housing and a second portion of the displaying region positioned on the second housing ; display the first execution screen in a third portion of the displaying region defined by a foldable portion of the displaying region corresponding to the second hinge assembly and positioned on the third housing ; in response to the input received while displaying the first execution screen of a second category, display the first execution screen in the second portion and the third portion defined by a foldable portion of the displaying region corresponding to the first hinge assembly; and display the second execution screen in the first portion.

According to an example embodiment, an electronic device may comprise a multi-foldable housing including: a first housing, a first hinge assembly including a first hinge, a second housing rotatably coupled to the first housing through the first hinge assembly, a second hinge assembly including a second hinge, and a third housing rotatably coupled to the second housing through the second hinge assembly; a flexible display disposed on front sides of the first housing, the second housing, and the third housing, memory, comprising one or more storage mediums, storing instructions, and at least one processor comprising processing circuitry, wherein the instructions, when executed by at least one processor, individually or in any combination, may cause the electronic device to: display a first execution screen in an entire displaying region of the flexible display in an unfolded state of the multi-foldable housing; receive an input for further displaying a second execution screen in the displaying region; in response to the input received while displaying the first execution screen of a first category, display the second execution screen in a first portion of the displaying region positioned on the first housing and a second portion of the displaying region positioned on the second housing, and display the first execution screen in a third portion of the displaying region defined by a foldable portion of the displaying region corresponding to the second hinge assembly and positioned on the third housing ; and in response to the input received while displaying the first execution screen of a second category, display the first execution screen in the second portion and the third portion defined by a foldable portion of the displaying region corresponding to the first hinge assembly, and display the first execution screen in the first portion.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a diagram illustrating an example of a first state of an example multi-foldable electronic device according to various example embodiments.

FIG. 1B is a diagram illustrating an example of a second state of an example multi-foldable electronic device according to various example embodiments.

FIG. 2A is a diagram illustrating a plan view of an electronic device from which a display is removed, in a first state of an example multi-foldable electronic device according to various example embodiments.

FIG. 2B is a diagram illustrating a rear view of a multi-foldable electronic device from which a rear cover and a sub display are removed, in a first state of an example multi-foldable electronic device according to various example embodiments.

FIG. 3A is a diagram illustrating an example of a first state of an example multi-foldable electronic device in which a deployment of housings is different according to various example embodiments.

FIG. 3B is a diagram illustrating an example of a second state of an example multi-foldable electronic device in which a deployment of housings is different according to various example embodiments.

FIG. 3C is a diagram illustrating an example multi-foldable electronic device in which a portion of a display is visible to the outside in a second state according to various example embodiments.

FIG. 4A and FIG. 4B are diagrams illustrating example states of an electronic device displaying one or more execution screens on a flexible display according to various example embodiments.

FIG. 5 is a block diagram illustrating an example configuration of an electronic device according to various example embodiments.

FIG. 6 is a flowchart illustrating example operations of an electronic device according to various example embodiments.

FIG. 7A, FIG. 7B, FIG. 7C, FIG. 7D, FIG. 7E, FIG. 7F, and FIG. 7G are diagrams illustrating example states of an electronic device displaying an execution screen according to an input for a visual object such as an icon according to various example embodiments.

FIG. 8A, FIG. 8B, and FIG. 8C are diagrams illustrating example states of an electronic device displaying an execution screen according to an input for a visual object such as an icon according to various example embodiments.

FIG. 9A and FIG. 9B are diagrams illustrating example states of an electronic device associated with an input for additionally displaying an execution screen according to various example embodiments.

FIG. 10A and FIG. 10B are diagrams illustrating example states of an electronic device associated with an input for additionally displaying an execution screen according to various example embodiments.

FIG. 11 is a diagram illustrating example states of an electronic device associated with an input for foldable portions of a flexible display according to various example embodiments.

FIG. 12A, FIG. 12B, and FIG. 12C are diagrams illustrating example states of an electronic device changing a layout of execution screens according to an input for a visual object such as a handle according to various example embodiments.

FIG. 13 is a diagram illustrating example states of an electronic device changing a layout of execution screens according to an input for a visual object such as a handle according to various example embodiments.

FIG. 14 is a diagram illustrating example states of an electronic device changing a layout of execution screens according to rotation of the electronic device according to various example embodiments.

FIG. 15 is a diagram illustrating example states of an electronic device changing a layout of execution screens according to an input for a visual object such as an icon according to various example embodiments.

FIG. 16 is a diagram illustrating example states of an electronic device including a cover display and a flexible display according to various example embodiments.

FIG. 17 is a diagram illustrating an example state of an electronic device displaying an execution screen having a layout based on a foldable portion of a flexible display according to various example embodiments.

### DETAILED DESCRIPTION

Hereinafter, various example embodiments of the present disclosure are described with reference to the accompanying drawings.

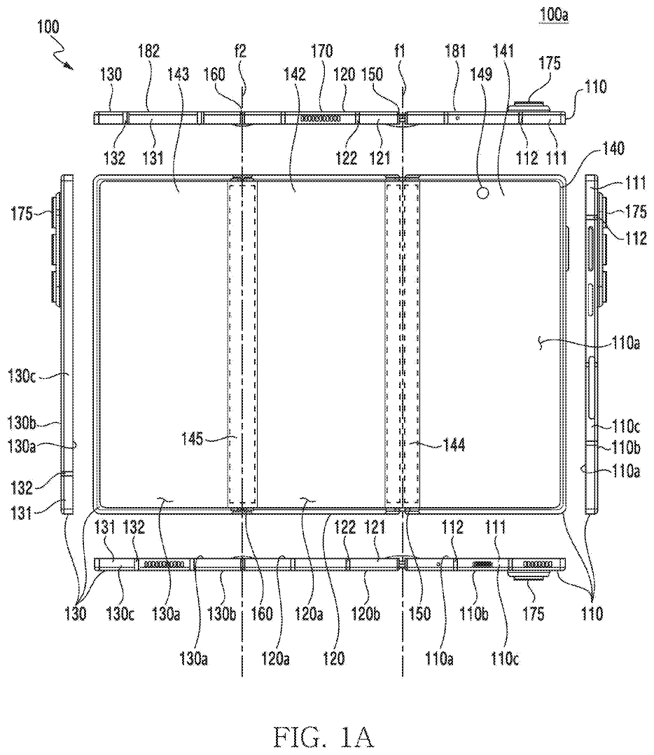

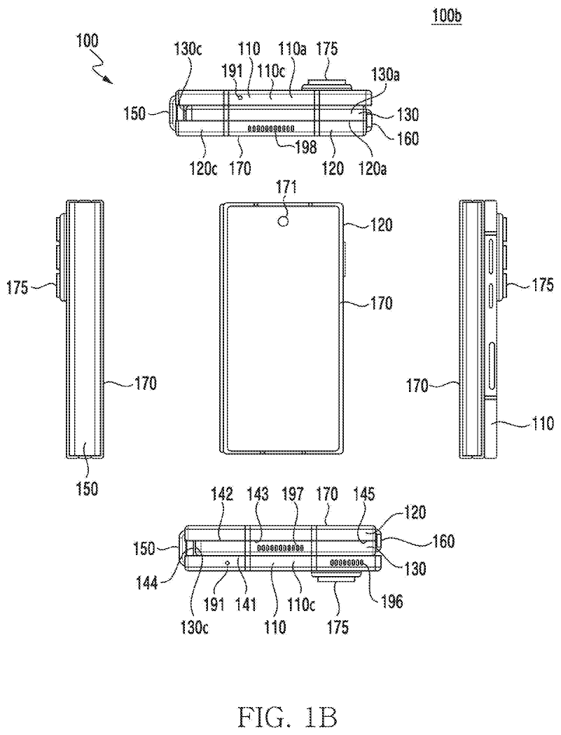

FIG. 1A is a diagram illustrating an example of a first state of an example multi-foldable electronic device according to various example embodiments. FIG. 1B illustrates an example of a second state of an example multi-foldable electronic device according to various example embodiments.

A portion of displays of an electronic device 100 may be flexible. Since a flexible display 140 of the electronic device 100 has flexibility, it may be folded at least once. The electronic device 100 may be referred to as a foldable electronic device or a multi-foldable electronic device in terms of having a structure in which the flexible display 140 is folded multiple times. The electronic device 100 may have a plurality of folding axes (e.g., a first folding axis f1 and a second folding axis f2). The electronic device 100 may be in a plurality of states including a first state 100a (e.g., an unfolded state) fully unfolded based on the plurality of folding axes f1 and f2, a second state 100b (e.g., a folded state) fully folded based on the plurality of folding axes f1 and f2, and a third state (e.g., an intermediate state) other than the first state 100a and the second state 100b. The third state may be a state of being fully folded or unfolded based on one of the plurality of folding axes f1 and f2 or partially folded based on at least one of the plurality of folding axes f1 and f2. The first state 100a is illustrated through FIG. 1A, and the second state 100b may be illustrated through FIG. 1B.

Referring to FIG. 1A and FIG. 1B, the electronic device 100 may include a first housing 110, a second housing 120, a third housing 130, a flexible display 140, a first hinge structure 150, a second hinge structure 160, and a display 170. The first housing 110 may be rotatably coupled to the second housing 120 through the first hinge structure 150. For example, the first housing 110 and the second housing 120 may rotate based on the first folding axis f1 through the first hinge structure 150 disposed along the first folding axis f1. The third housing 130 may be rotatably coupled to the second housing 120 through the second hinge structure 160. For example, the second housing 120 and the third housing 130 may rotate based on the second folding axis f2 through the second hinge structure 160 disposed along the second folding axis f2.

The flexible display 140 may form at least a portion of an exterior of the electronic device 100. The flexible display 140 may be partially disposed in the first housing 110, the second housing 120, and the third housing 130. The flexible display 140 may define a front side of the electronic device 100 by forming a side 110a of the first housing 110, a side 120a of the second housing 120, and a side 130a of the third housing 130. The flexible display 140 may include a region in which a front camera 149 is positioned. The flexible display 140 may include an opening for the front camera 149 in the region. However, the disclosure is not limited thereto, and the front camera 149 may be positioned below a region corresponding to the region of the flexible display 140. The flexible display 140 may provide visual information to a user through the region, and the front camera 149 may obtain an image of an external object positioned in a direction facing a front side of the electronic device 100 through the region of the flexible display 140.

The flexible display 140 may include a first planar portion 141, a second planar portion 142, a third planar portion 143, a first deformation portion 144, and a second deformation portion 145. The first planar portion 141 may be disposed on the side 110a of the first housing 110. The second planar portion 142 may be disposed on the side 120a of the second housing 120. The third planar portion 143 may be disposed on a side 130b of the third housing 130. The first deformation portion 144 may be positioned between the first planar portion 141 and the second planar portion 142. For example, the first deformation portion 144 may be disposed on the first hinge structure 150 connecting the first housing 110 and the second housing 120. The second deformation portion 145 may be disposed between the second planar portion 142 and the third planar portion 143. For example, the second deformation portion 145 may be disposed on the second hinge structure 160 connecting the second housing 120 and the third housing 130.

The first planar portion 141, the second planar portion 142, and the third planar portion 143 of the flexible display 140 may maintain a plane regardless of a state of the electronic device 100. The first deformation portion 141 and the second deformation portion 142 of the flexible display 140 may be unfolded or bent according to a state of the electronic device 100.

The display 170, a first rear cover 181, and a second rear cover 182 may form at least a portion of the exterior of the electronic device 100. The first rear cover 181 may form another side 110b of the first housing 110, the display 170 may form another side 120b of the second housing 120, and the second rear cover 182 may be formed on another side 130b of the third housing 130. The display 170, the first rear cover 181, and the second rear cover 182 may define a rear side of the electronic device 100. The first rear cover 181 may include a structure (e.g., an opening) for exposing a rear camera 175 disposed in the first housing 110. The display 170 may include a region in which a front camera 171 is positioned. The display 170 may include an opening for the front camera 171 in the region.

A lateral side 110c of the first housing 110 disposed between the side 110a of the first housing 110 and the another side 110b of the first housing 110 may surround an inner space of the first housing 110 together with the first hinge structure 150, the side 110a of the first housing 110, and the another side 110b of the first housing 110. A lateral side 120c of the second housing 120 disposed between the side 120a of the second housing 120 and the another side 120b of the second housing 120 may surround an inner space of the second housing 120 together with the first hinge structure 150, the second hinge structure 160, the side 120a of the second housing 120, and the another side 120b of the second housing 120. A lateral side 130c of the third housing 130 disposed between the side 130a of the third housing 130 and the another side 130b of the third housing 130 may surround an inner space of the third housing 130 together with the second hinge structure 160, the side 130a of the third housing 130, and the another side 130b of the third housing 130.

The first housing 110, the second housing 120, and the third housing 130 may include conductive portions 111, 121, and 131 and non-conductive portions 112, 122, and 332 disposed on the lateral side 110c of the first housing 110, the lateral side 120c of the second housing 120, and the lateral side 130c of the third housing 130. The first conductive portions 111, and the first non-conductive portions 112 disposed between the first conductive portions 111 may define the lateral side 110c of the first housing 110. The second conductive portions 121, and the second non-conductive portions 122 disposed between the second conductive portions 121 may define the lateral side 120c of the second housing 120. The third conductive portions 131, and the third non-conductive portions 132 disposed between the third conductive portions 131 may define the lateral side 130c of the third housing 130. A portion of the conductive portions 111, 121, and 131 may function as an antenna radiator.

The electronic device 100 may include at least one microphone hole 191 and at least one speaker hole 196, 197, and/or 198. In an embodiment, the at least one microphone hole 191 may be formed in a partial region of the lateral side 110c of the first housing 110. A microphone (not illustrated) for obtaining external sound may be disposed inside the at least one microphone hole 191. The microphone may include a plurality of microphones to detect a direction of sound. For example, a microphone may be disposed in a microphone hole positioned at an upper end of the first housing 110, and another microphone may be disposed in a microphone hole positioned at a lower end of the first housing 310.

The at least one speaker hole 196, 197, and/or 198 may be disposed on a lateral side of a housing in which a speaker is disposed. For example, the first speaker hole 196 may be disposed on the lateral side 110c of the first housing 110, the second speaker hole 197 may be disposed on the lateral side 130c of the third housing 130, and the third speaker hole 198 may be disposed on the lateral side 120c of the second housing 120. The first speaker hole 196 and the second speaker hole 197 may be disposed at an upper end of the electronic device 100, and the third speaker hole 198 may be disposed at a lower end of the electronic device. However, the disclosure is not limited thereto, and a position of a speaker hole may be formed toward a lateral side of a housing adjacent to a speaker in the housing.

The first hinge structure 150 may rotatably connect the first housing 110 and the second housing 120. The second hinge structure 160 may rotatably connect the second housing 120 and the third housing 130. Each of the first hinge structure 150 and the second hinge structure 160 may be configured to change a state of the electronic device 100 to another state by rotating the housings 110, 120, and 130.

Referring to FIG. 1A, the first hinge structure 150 and the second hinge structure 160 may be configured to provide the first state 100a in which the side 110a of the first housing 110, the side 120a of the second housing 120, and the side 130a of the third housing 130 face the same direction. In the first state 100a, the first deformation portion 144 and the second deformation portion 145 may be disposed on the same plane as the first planar portion 141, the second planar portion 142, and the third planar portion 143. For example, the first hinge structure 150 and the second hinge structure 160 may provide the first deformation portion 144 and the second deformation portion 145 substantially forming a plane in the first state 100a.

Referring to FIG. 1B, in the second state 100b, the first hinge structure 150 may be configured to provide a state in which the side 110a of the first housing 110 and the side 120a of the second housing 120 face opposite directions, and the second hinge structure 160 may be configured to provide a state in which the side 120a of the second housing 120 and the side 130a of the third housing 130 face opposite directions. For example, in the second state 100b, the first deformation portion 144 may be bent such that the first planar portion 141 and the second planar portion 142 face opposite directions. In the second state 100b, the second deformation portion 145 may be bent such that the second planar portion 142 and the third planar portion 143 face opposite directions.

In the second state 100b, the third housing 130 may be positioned between the first housing 110 and the second housing 120. At least a portion of the lateral side 130c of the third housing 130 may face the first deformation part 144 disposed on the first hinge structure 150.

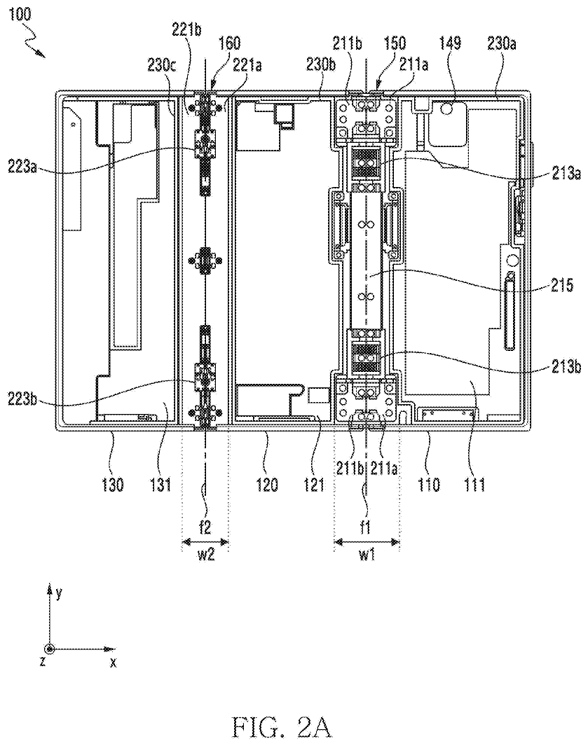

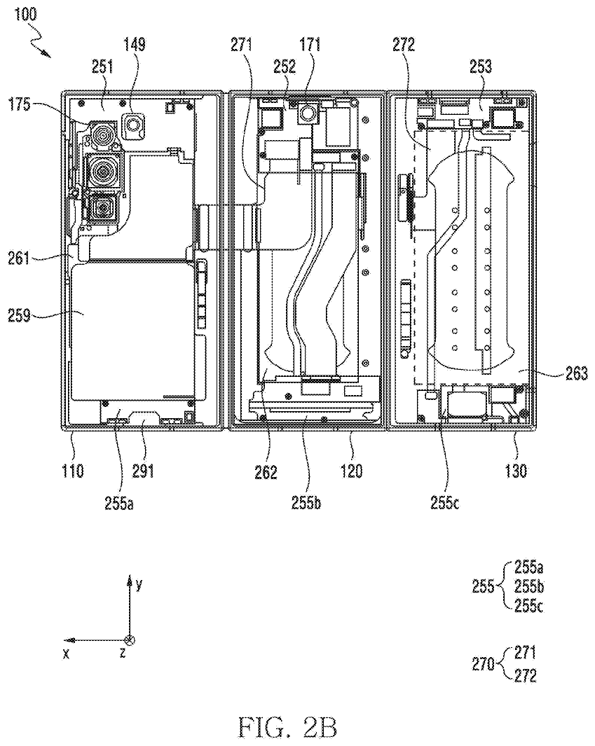

A detailed description of the first hinge structure 150 and the second hinge structure 160 configured to provide a plurality of states (e.g., the first state 100a, the second state 100b, or the third state) of the electronic device 100 may be described in greater detail below with reference to FIG. 2A.

FIG. 2A is a diagram illustrating a plan view of an electronic device from which a display is removed, in a first state of an example multi-foldable electronic device according to various example embodiments. FIG. 2B is a diagram illustrating a rear view of a multi-foldable electronic device from which a rear cover and a sub display are removed, in a first state of an example multi-foldable electronic device according to various example embodiments.

Referring to FIG. 2A, a first hinge structure 150 of an electronic device 100 may include at least one first hinge plate 211a, at least one second hinge plate 211b, sets of a plurality of hinge gears 213a and 213b, and a support plate 215. The at least one first hinge plate 211a of the first hinge structure 150 may be coupled to a first support portion 111 of a first housing 110. The first support portion 111 may support electronic components disposed in the first housing 110. The at least one second hinge plate 211b of the second hinge structure 160 may be coupled to a second support portion 121 of a second housing 120. The second support portion 121 may support electronic components disposed in the second housing 120. Each set of the sets of the first hinge gear 213a and 213b may rotatably connect the first support portion 111 and the second support portion 121 based on a first folding axis f1.

A second hinge structure 160 of the electronic device 100 may include at least one third hinge plate 221a, at least one fourth hinge plate 221b, and sets of a plurality of hinge gears 223a and 223b. The at least one third hinge plate 221a of the second hinge structure 160 may be coupled to the second support portion 121 of the second housing 120. The at least one fourth hinge plate 221b of the second hinge structure 160 may be coupled to a third support portion 131 of a third housing 130. The third support portion 113 may support electronic components disposed in the third housing 130. Each set of the sets of the second hinge gear 223a and 223b may rotatably connect the second support portion 121 and the third support portion 131 based on a second folding axis f2.

A width w1 of the first hinge structure 150 disposed along the first folding axis f1 may be wider than a width w2 of the second hinge structure 160 disposed along the second folding axis f2. A difference between the width w1 of the first hinge structure 150 and the width w2 of the second hinge structure 160 may be equal to or greater than a thickness of the third housing 130. For example, in the second state 100b of FIG. 1B, the width w1 of the first hinge structure 150 may be formed to be wider than the width w2 of the second hinge structure 160 such that the third housing 130 is disposed between the first housing 110 and the second housing 120.

The electronic device 100 may further include waterproof members 230a, 230b, and 230c. The waterproof members 230a, 230b, and 230c may reduce moisture or a foreign substance flowing from the outside to the inside of the electronic device 100 by being attached to each of support portions 111, 121, and 131 of the housings 110, 120, and 130 and the flexible display 140. The waterproof members 230a, 230b, and 230c may include a waterproof tape, a waterproof adhesive, a double-sided tape, or an adhesive.

Referring to FIG. 2B, the electronic device 100 may further include a first printed circuit board 251, a second printed circuit board 252, a third printed circuit board 253, and a plurality of sub printed circuit boards 255.

The first printed circuit board 251 may be disposed in the first housing 110. The first printed circuit board 251 may contact another side of the first support portion 111 of the first housing 110. A plurality of electronic components for driving the electronic device 100 may be disposed on the first printed circuit board 251. The plurality of electronic components may include at least one processor including processing circuitry, at least one memory including a storage medium, wireless communication circuitry for performing wireless communication with an external electronic device, and one or more rear cameras 175. The one or more rear cameras 175 may be visually exposed through a partial structure (e.g., an opening) of a rear side 110b of the first housing 110.

The second printed circuit board 252 may be disposed in the second housing 120. The second printed circuit board 252 may contact another side of the second support portion 121 of the second housing 120. A plurality of electronic components may be disposed on the second printed circuit board 252. The plurality of electronic components disposed on the second printed circuit board 252 may include components that may assist the plurality of electronic components disposed on the first printed circuit board 251 or operate independently. The plurality of electronic components disposed on the second printed circuit board 252 may include circuitry for driving a speaker and/or a front camera 171 and a display (e.g., the display 170 of FIG. 1B).

The third printed circuit board 253 may be disposed in the third housing 130. The third printed circuit board 253 may contact another side of the third support portion 131 of the third housing 130. A plurality of electronic components may be disposed on the third printed circuit board 253. The plurality of electronic components disposed on the third printed circuit board 253 may include components that may assist the plurality of electronic components disposed on the first printed circuit board 251 and/or the second printed circuit board 252 or operate independently. The plurality of electronic components disposed on the third printed circuit board 253 may include circuitry for driving the flexible display (e.g., the display 140 of FIG. 1A).

A first sub printed circuit board 255a may contact another side of the first support portion 111 of the first housing 110. A plurality of electronic components may be disposed on the first sub printed circuit board 255a. The plurality of electronic components disposed on the first sub printed circuit board 255a may assist the plurality of electronic components disposed on the first printed circuit board 251. A speaker may be disposed on the first sub printed circuit board 255a. The first sub printed circuit board 255a may be connected to an interface 291 configured to be electrically connected to an external electronic device. Power or data may be transmitted and received to and from an external electronic device through the interface 291.

A second sub printed circuit board 255b may contact another side of the second support portion 121 of the second housing 120. A plurality of electronic components may be disposed on the second sub printed circuit board 255b. The plurality of electronic components disposed on the second sub printed circuit board 255b may assist the plurality of electronic components disposed on the second printed circuit board 252. A motor may be disposed on the second sub printed circuit board 255b. The motor may be configured to provide a notification provided from the electronic device 100 through tactile information.

A third sub printed circuit board 255c may contact another side of the third support portion 131 of the third housing 130. A plurality of electronic components may be disposed on the third sub printed circuit board 255c. The plurality of electronic components disposed on the third sub printed circuit board 255c may assist the plurality of electronic components disposed on the third printed circuit board 253. A speaker may be disposed on the third sub printed circuit board 255c. A plurality of speakers disposed on the first sub printed circuit board 255a, the second printed circuit board 252, and the third sub printed circuit board 255c may be configured to provide audio information from the electronic device 100. Printed circuit boards or sub printed circuit boards on which the plurality of speakers are disposed are examples, and may be disposed at another position. A portion of the plurality of sub printed circuit boards 255 may be omitted according to a deployment of electronic components, or another sub printed circuit board other than the plurality of sub printed circuit boards 255 may be added.

The electronic device 100 may further include a plurality of batteries 261, 262, and 263. Each of the plurality of batteries 261, 262, and 263 may be coupled to the support portions 111, 121, and 131 in the housings 110, 120, and 130 of the electronic device 100. The support portions 111, 121, and 131 may support the plurality of rechargeable batteries 261, 262, and 263, respectively. The plurality of batteries 261, 262, and 263 may be disposed in a recessed portion in the support portions 111, 121, and 131.

The electronic device 100 may further include an antenna module 259. The antenna module 259 may be disposed in the first housing 110. The antenna module 259 may be disposed between the first battery 261 and a first rear cover 181. The antenna module 259 may include, for example, a near field communication (NFC) antenna, a wireless charging antenna, and/or a magnetic secure transmission (MST) antenna. The antenna module may, for example, perform short-range communication with an external device or wirelessly transmit and receive power to and from an external device.

The first battery 261 may be disposed, on the first support portion 111 of the first housing 110, between the first printed circuit board 251 and the first sub printed circuit board 255a. The second battery 262 may be disposed, on the second support portion 121 of the second housing 120, between the second printed circuit board 252 and the second sub printed circuit board 255b. The third battery 263 may be disposed, on the third support portion 131 of the third housing 130, between the third printed circuit board 253 and the third sub printed circuit board 255c.

In an embodiment, the housings 110, 120, and 130 of the electronic device 100 may refer, for example, to a configuration or a structure forming at least a portion of an exterior of the electronic device 100. In this respect, at least a portion of the flexible display 140, the display 170, the first rear cover 181, and a second rear cover 182 forming the exterior of the electronic device 100 may be referred to as a housing of the electronic device 100.

The electronic device 100 may include a plurality of flexible printed circuit boards 270. The plurality of flexible printed circuit boards 270 may electrically connect electronic components disposed in each of the housings 110, 120, and 130 to each other. For example, a first flexible printed circuit board 271 may electrically connect the first printed circuit board 251 and the second printed circuit board 252. A second flexible printed circuit board 272 may electrically connect the second printed circuit board 252 and the third printed circuit board 153. However, the disclosure is not limited thereto, and at least one of the plurality of flexible printed circuit boards 270 may electrically connect all of the first printed circuit board 251, the second printed circuit board 252, and the third printed circuit board 253. The plurality of flexible printed circuit boards 270 may extend to each of the housings 110, 120, and 130 by passing through the first hinge structure 250 or the second hinge structure 260.

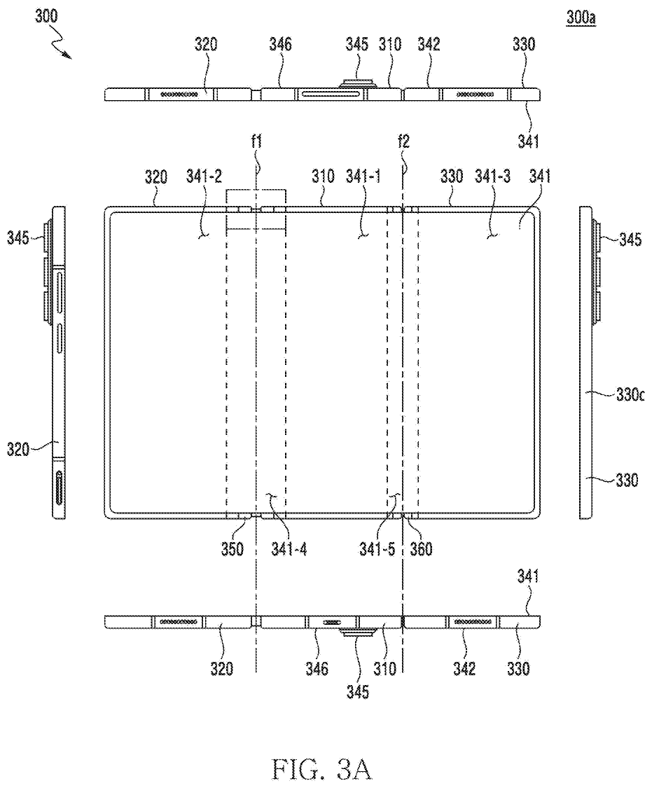

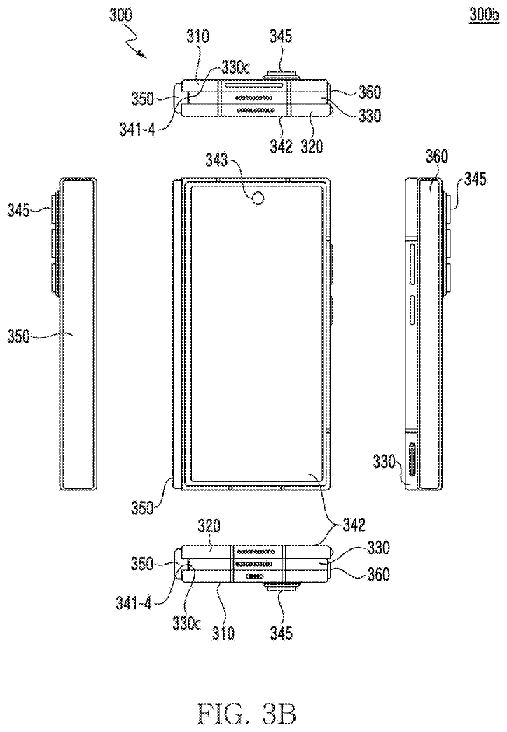

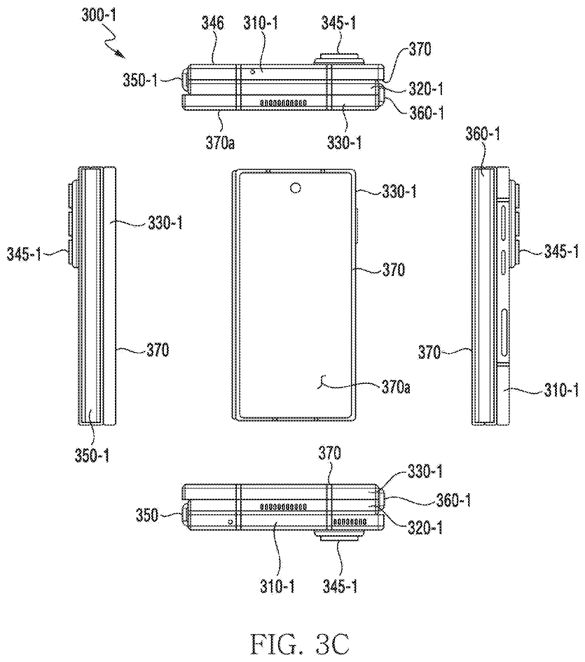

FIG. 3A is a diagram illustrating an example of a first state of an example multi-foldable electronic device in which a deployment of housings is different according to various example embodiments. FIG. 3B is a diagram illustrating an example of a second state of an example multi-foldable electronic device in which a deployment of housings is different according to various example embodiments.

Referring to FIG. 3A and FIG. 3B, an electronic device 300 may include a first housing 310, a second housing 320, a third housing 330, a flexible display 341, a display 342, a first hinge structure 350, a second hinge structure 360, and a display 370. The first housing 310 may be disposed between the second housing 320 and the third housing 330. The first housing 310 may be rotatably coupled to the second housing 320 through the first hinge structure 350. For example, the first housing 310 and the second housing 320 may rotate based on a first folding axis f1 through the first hinge structure 350 disposed along the first folding axis f1. The third housing 330 may be rotatably coupled to the first housing 310 through the second hinge structure 360. For example, the first housing 310 and the third housing 330 may rotate based on a second folding axis f2 through the second hinge structure 360 disposed along the second folding axis f2. A rear camera 345 may be exposed through a rear plate 346 of the first housing 310. The third housing 330 may include the display 342.

Referring to FIG. 3A, the first hinge structure 350 and the second hinge structure 360 may be configured to provide a first state 300a in which a first planar portion 341-1 of the flexible display 341 on the first housing 310, a second planar portion 341-2 of the flexible display 341 on the second housing 320, and a third planar portion 341-3 of the flexible display 341 on the third housing 330 face the same direction. A first deformation portion 341-4 may be disposed between the first planar portion 341-1 and the second planar portion 341-2. A second deformation portion 341-5 may be disposed between the first planar portion 341-1 and the third planar portion 341-3. In the first state 300a, the first deformation portion 341-4 and the second deformation portion 341-5 may be disposed on the same plane as the first planar portion 341-1, the second planar portion 341-2, and the third planar portion 341-3. For example, the first hinge structure 350 and the second hinge structure 360 may provide the first deformation portion 341-4 and the second deformation portion 341-5 substantially forming a plane in the first state 300a.

Referring to FIG. 3B, in a second state 300b, the first hinge structure 350 may be configured to provide a state in which the first planar portion 341-1 of the flexible display 341 and the second planar portion 341-2 of the flexible display 341 face opposite directions, and the second hinge structure 360 may be configured to provide a state in which the first planar portion 341-1 of the flexible display 341 and the third planar portion 341-3 of the flexible display 341 face opposite directions. For example, in the second state 300b, the first deformation portion 341-4 may be bent such that the first planar portion 341-1 and the second planar portion 341-2 face opposite directions. In the second state 300b, the second deformation portion 341-5 may be bent such that the first planar portion 341-1 and the third planar portion 341-3 face opposite directions.

In the second state 300b, the third housing 330 may be positioned between the first housing 310 and the second housing 320. At least a portion of a lateral side 330c of the third housing 330 may face the first deformation part 341-4 disposed on the first hinge structure 350.

The display 342 may include a region in which a camera 343 is positioned. The display 342 may include an opening for the camera 343 in the region.

The electronic device 300 of FIG. 3A and FIG. 3B may be substantially identical to the electronic device 100 of FIG. 1A and FIG. 1B, except that the third housing 330 of the electronic device 300 is connected to the first housing 310.

FIG. 3C is a diagram illustrating an example multi-foldable electronic device in which a portion of a display is visible to the outside in a second state according to various example embodiments.

The flexible displays 140 and 341 of the electronic devices 100 and 300 of FIG. 1A, FIG. 1B, FIG. 2A, FIG. 2B, FIG. 3A, and FIG. 3B may not be substantially visible to the outside of the electronic devices 100 and 300 in the second states 100b and 300b. A portion 370a of a flexible display 370 of an electronic device 300-1 of FIG. 3C may function as a sub display (e.g., the displays 170 and 342 of FIG. 1A and FIG. 1B) by being visible to the outside in a second state 300b.

Referring to FIG. 3C, the electronic device 300-1 may include a first housing 310-1, a second housing 320-1, a third housing 330-1, a first hinge structure 350-1, a second hinge structure 360-1, and the flexible display 370. The first housing 310-1 may be rotatably coupled to the second housing 320-1 through the first hinge structure 350-1. The third housing 330-1 may be rotatably coupled to the first housing 310-1 through the second hinge structure 360-1. A rear camera 345-1 may be exposed through a rear plate 346 of the first housing 310-1.

When changing from an unfolded state to a folded state, a portion of the flexible display 370 disposed on the first housing 310-1 and a rigid portion of the flexible display 370 disposed on the second housing 320-1 may face each other. For example, in the second state 300b, a rigid portion of the flexible display 370 disposed on the first housing 310-1 and the rigid portion of the flexible display 370 disposed on the second housing 320-1 may not be visible to the outside. The portion of the flexible display 370 disposed on the first housing 310-1 and a portion of the flexible display 370 disposed on the second housing 320-1 may be positioned in the inside by being folded and surrounded by configurations of the electronic device 300-1. In the second state, the rigid portion 370a of the flexible display 370 disposed on the third housing 330-1 may face the outside of the electronic device 300-1. For example, a front side of the third housing 330-1 on which the flexible display 370 is disposed may be exposed to the outside of the electronic device 300-1. In the second state, the rigid portion 370a of the flexible display 370 disposed on the third housing 330-1 may be configured to provide visual information to the outside.

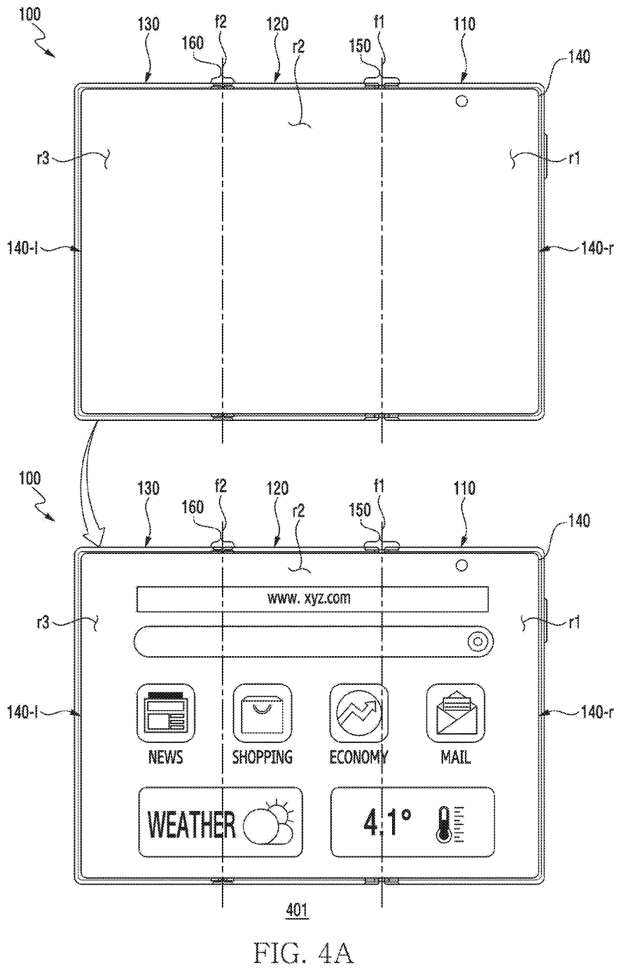

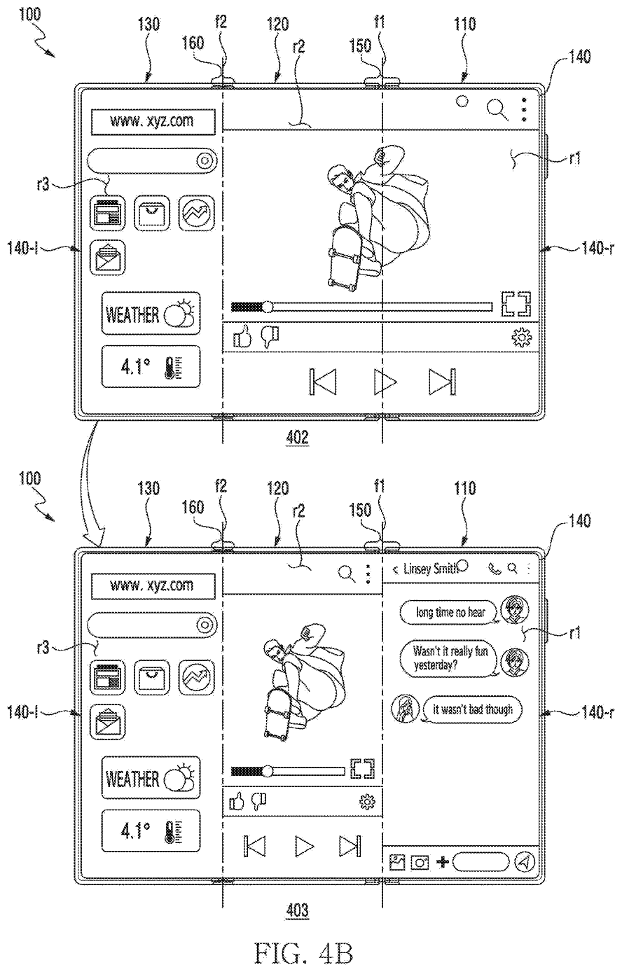

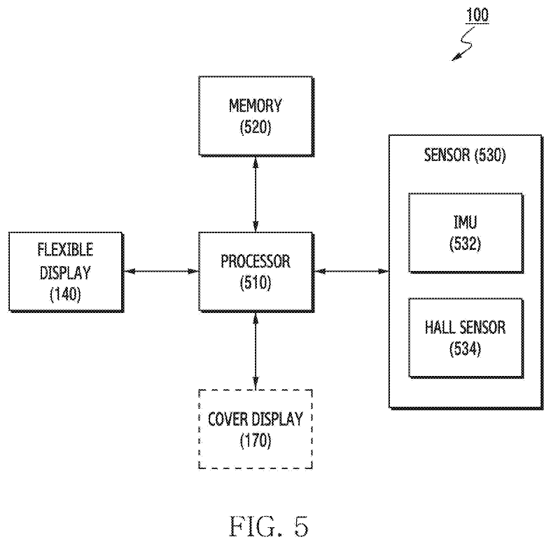

FIG. 4A and FIG. 4B are diagrams illustrating example states 401, 402, and 403 of an electronic device 100 displaying one or more execution screens on a flexible display 140 according to various example embodiments. A housing of the electronic device 100 may be referred to as a case of the electronic device 100. The housing may include plastic, glass, ceramic, fiber materials, metal (e.g., stainless steel, aluminum, and/or titanium), other suitable materials, or a combination thereof. The housing may include an internal frame structure and/or one or more structures forming a surface of the housing. An example of a hardware configuration included in the housing of the electronic device 100 is described in greater detail below with reference to FIG. 5.

Referring to FIG. 4A to FIG. 4B, the housing of the electronic device 100 may include a first housing part 110, a first hinge assembly 150, a second housing part 120, a second hinge assembly 160, and a third housing part 130. The second housing part 120 may be rotatably coupled to the first housing part 110 through the first hinge assembly 150. For example, the first housing part 110 may rotate with respect to the second housing part 120 based on a first folding axis f1 of the first hinge assembly 150. The third housing part 130 may be rotatably coupled to the second housing part 120 through the second hinge assembly 160. For example, the third housing part 130 may rotate with respect to the second housing part 120 based on a second folding axis f2 of the second hinge assembly 160. In terms of including a plurality of folding axes (e.g., the first folding axis f1 and the second folding axis f2), the housing of the electronic device 100 including the first housing part 110, the first hinge assembly 150, the second housing part 120, the second hinge assembly 160, and the third housing part 130 may be referred to as a multi-foldable housing. The electronic device 100 including the multi-foldable housing may be referred to as a multi-foldable electronic device.

Each of parts (e.g., the first housing part 110, the second housing part 120, and the third housing part 130) of the housing of the electronic device 100 may be a rigid body and may be referred to as a housing assembly, a sub-housing, a flat housing, and/or a rigid housing. The electronic device 100 including three rigid housings (e.g., the first housing part 110, the second housing part 120, and the third housing part 130) may be referred to as a trifold electronic device.

Each of hinge assemblies (e.g., the first hinge assembly 150 and the second hinge assembly 160) of the housing of the electronic device 100 may be referred to as a hinge housing, a foldable housing, a rotatable housing, a joint housing, a hinge, and/or a flexible housing. By the first hinge assembly 150, a relative position, a posture, an angle, a shape, and/or a distance of the first housing part 110 and the second housing part 120 may be changed due to an external force. In the present disclosure, a first angle may refer to an angle (e.g., an angle formed on a front side) between the first housing part 110, the first hinge assembly 150 (or the first folding axis f1), and the second housing part 120. By the second hinge assembly 160, a relative position, a posture, an angle, a shape, and/or a distance of the second housing part 120 and the third housing part 130 may be changed due to an external force. In the present disclosure, a second angle may refer to an angle (e.g., an angle formed on a front side) between the second housing part 120, the second hinge assembly 160 (or the second folding axis f2), and the third housing part 130.

In an embodiment, a state (or a shape) of the electronic device 100 may be classified into a plurality of preset (e.g., specified) states based on the first angle of the first folding axis f1 and the second angle of the second folding axis f2. For example, the plurality of preset states may include an unfolded state in which both the first angle and the second angle are substantially a straight angle (e.g., about 180°). The unfolded state may be referred to as a fully unfolded state, an open state, a fully open state, an unfolding state, a flat state, an outspread state, and/or a planar state. In the unfolded state, the flexible display 140 may have a planar shape. In the unfolded state, directions of portions of the flexible display 140 respectively positioned on the first housing part 110, the second housing part 120, and the third housing part 130 may be parallel to each other and/or may coincide with each other.

For example, the plurality of preset states may include a folded state in which both the first angle and the second angle are substantially 0°. The folded state may be referred to as a fully folded state, a folding state, a closed state, and/or a fully-closed state. In the folded state, the flexible display 140 may be visually covered and/or hidden by the first housing part 110, the second housing part 120, and the third housing part 130. In the folded state, a size of a visible flexible display 140 may be substantially 0.

For example, the plurality of preset states may include an intermediate state between the unfolded state and the folded state. In the intermediate state, at least one of the first angle and the second angle may be less than a straight angle. In the intermediate state, both the first angle and the second angle may be greater than 0°. In an e-shaped (or G-shaped) foldable electronic device (e.g., the electronic device 100 of FIG. 4A and/or FIG. 4B), the intermediate state may be referred to as an in-fold state, a sub unfolded state (or a sub fold state), a sub folding state, and/or a concave state. In an S-shaped (or Z-shaped) foldable electronic device, the intermediate state may be referred to as an out-fold state and/or a convex state. In the intermediate state, at least two of directions of portions of the flexible display 140 respectively positioned on the first housing part 110, the second housing part 120, and the third housing part 130 may be different from each other.

FIG. 4A to FIG. 4B illustrate, according to an example embodiment, an appearance of a front side of the electronic device 100 (or the housing of the electronic device 100) on which the flexible display 140 is positioned. The flexible display 140 may extend from a side of the first housing part 110, across a side of the second housing part 120, to a side of the third housing part 130. For example, the flexible display 140 may be disposed on front sides of the first housing part 110, the second housing part 120, and the third housing part 130. Since the flexible display 140 is positioned on the first hinge assembly 150 and the second hinge assembly 160, portions of the flexible display 140 respectively positioned on the first folding axis f1 of the first hinge assembly 150 and the second folding axis f2 of the second hinge assembly 160 may be folded or bent due to an external force. By rotation at the first folding axis f1 and/or rotation at the second folding axis f2, a crease may be formed on the flexible display 140. The crease may have, on the flexible display 140, a shape parallel to folding axes (e.g., the first folding axis f1 and/or the second folding axis f2).

The flexible display 140 positioned on the first housing part 110, the second housing part 120, and the third housing part 130 may include a first portion r1 positioned on the first housing part 110, a second portion r2 positioned on the second housing part 120, and a third portion r3 positioned on the third housing part 130. The first portion r1 may be distinguished from a remaining portion (e.g., the second portion r2) of the flexible display 140 by a first foldable portion of the flexible display 140 corresponding to the first hinge assembly 150. The second portion r2 may be distinguished from a remaining portion (e.g., the first portion r1 and the third portion r3) of the flexible display 140 by the first foldable portion and a second foldable portion of the flexible display 140 corresponding to the second hinge assembly 160. The third portion r3 may be distinguished from a remaining portion (e.g., the second portion r2) of the flexible display 140 by the second foldable portion.

Referring to FIG. 4A, the example state 401 of displaying a (single) execution screen on an entire displaying region (or active region) of the flexible display 140 is illustrated. Although the example state 401 of displaying an execution screen provided (or generated) by a web browser based on execution of the web browser is illustrated, the disclosure is not limited thereto. According to an embodiment, the electronic device 100 may display an execution screen through the entire displaying region of the flexible display 140 in an unfolded state in which the flexible display 140 has a flat shape.

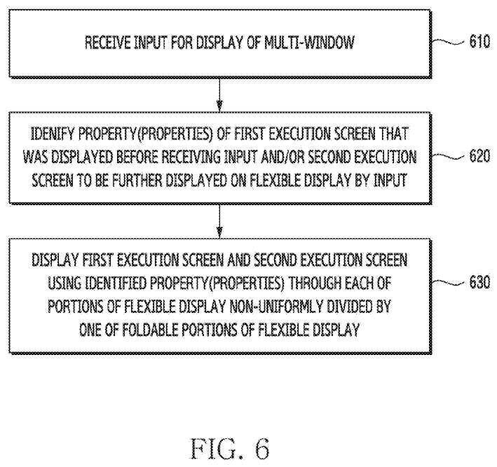

In an embodiment, the electronic device 100 supporting multi-tasking (or multi-window) may execute a plurality of programs (or software applications) substantially simultaneously. The electronic device 100 may display, on the flexible display 140, a plurality of execution screens respectively provided by the simultaneously executed programs. An example operation of the electronic device 100 displaying the plurality of execution screens on the flexible display 140 is described in greater detail below with reference to FIG. 6 to FIG. 16.

For example, a layout of execution screens simultaneously displayed on the flexible display 140 may be classified into picture-by-picture (PBP) or picture-in-picture (PIP). Based on the PIP, the electronic device 100 may display execution screens on the flexible display 140 such that a specific execution screen overlaps another execution screen. Based on the PBP, the electronic device 100 may display execution screens on the flexible display 140 such that a specific execution screen is displayed next to another execution screen. When the execution screens occupy different portions of a displaying region based on the PBP, a boundary line of the execution screens may be formed on the flexible display 140.

In an embodiment, when displaying execution screens based on the PBP, the electronic device 100 may change properties of the execution screens such that a boundary line of the execution screens is positioned on one folding axis among folding axes (e.g., the first folding axis f1 and the second folding axis f2). Since the boundary line is positioned on the folding axis, the boundary line may be positioned on a foldable portion of the flexible display 140 foldable by the folding axis. Since a user tends to focus on content of one of the execution screens rather than the boundary line, a probability (or time) that the foldable portion on which the boundary line is positioned is focused on (or visible) by the user may be reduced. For example, content of the execution screen may not be distorted by the foldable portion, and the user may view the content without the distortion.

Referring to FIG. 4B, the example states 402 and 403 of the electronic device 100 displaying a plurality of execution screens on the flexible display 140 are illustrated. In the state 402 displaying two execution screens, the electronic device 100 may display execution screens having a boundary line formed based on the second foldable portion positioned on the second folding axis f2 among the first folding axis f1 and the second folding axis f2. For example, based on the second hinge assembly 160 (or the second foldable portion), execution screens having an area ratio (or a size ratio) of 1:2 may be displayed. In an embodiment of the electronic device 100 including two folding axes, a displaying region of the flexible display 140 may be non-uniformly divided by one folding axis.

In the example state 402 of FIG. 4B, among portions of the displaying region non-uniformly divided by the second folding axis f2, the electronic device 100 may display a first execution screen (e.g., an execution screen of a web browser) in the third portion r3 of the displaying region positioned on the third housing part 130 and may display a second execution screen (e.g., an execution screen of a video playback application) in a combination of the first portion r1 and the second portion r2 of the displaying region. The electronic device 100 may logically divide the displaying region of the flexible display 140 based on a foldable portion (e.g., a crease) of the flexible display 140 and/or a hinge assembly (e.g., the first hinge assembly 150 and the second hinge assembly 160) of the flexible display 140. Each of logically divided portions (e.g., the first portion r1, the second portion r2, and the third portion r3) of the displaying region may be referred to as a logical display.

For example, the electronic device 100 may respectively allocate the logically divided portions of the displaying region to execution screens to be simultaneously displayed on the flexible display 140. The electronic device 100 may cause a specific execution screen be displayed larger in the flexible display 140 than another execution screen by allocating, to the specific execution screen, the relatively larger number of portions (adjacent portions on the flexible display 140). The electronic device 100 may non-uniformly map or determine portions of the flexible display 140 on which the execution screens are to be displayed, according to the number of programs executed to provide the execution screens and/or a type (e.g., a category, a group, a genre, and/or a classification) of the programs.

In the example state 402 of FIG. 4B, the electronic device 100 may control the flexible display 140 such that an execution screen of a video playback application is displayed in at least two portions (e.g., the first portion r1 and the second portion r2) of the displaying region of the flexible display 140, and such that an execution screen of a web browser is displayed in a remaining portion (e.g., the third portion r3) of the displaying region of the flexible display 140.

In the state 402, when further receiving an input for additionally executing a program, the electronic device 100 may switch from the state 402 to the state 403. In the example state 403 of FIG. 4B, the electronic device 100 may display three execution screens in portions (e.g., the first portion r1, the second portion r2, and the third portion r3) of the displaying region of the flexible display 140, respectively. For example, the electronic device 100 may display an execution screen of a messenger application in the first portion r1 of the displaying region of the flexible display 140, may display an execution screen of a video playback application in the second portion r2, and may display an execution screen of a web browser application in the third portion r3.

Referring to the example state 403 of FIG. 4B, when displaying three execution screens, the electronic device 100 including three foldable housing parts (e.g., the first housing part 110, the second housing part 120, and the third housing part 130) may respectively display or allocate the three execution screens on portions (e.g., the first portion r1, the second portion r2, and the third portion r3) of the displaying region respectively positioned on the housing parts. For example, the electronic device 100 may display an execution screen of a messenger application in the first portion r1 of the flexible display 140 positioned on the first housing part 110, may display an execution screen of a video playback application in the second portion r2 of the flexible display 140 positioned on the second housing part 120, and may display an execution screen of the messenger application in the third portion r3 of the flexible display 140 positioned on the third housing part 130. In the state 403 displaying three execution screens, the electronic device 100 may control the flexible display 140 such that sizes of the portions of the flexible display 140 in which the execution screens are displayed coincide with each other.

As described above, according to an example embodiment, in the unfolded state, when displaying a plurality of execution screens on the flexible display 140, the electronic device 100 may separately display the plurality of execution screens based on at least one of folding axes (e.g., the first folding axis f1 and the second folding axis f2). When displaying two execution screens (e.g., the state 402 of FIG. 4B), sizes of the execution screens displayed by the electronic device 100 on the flexible display 140 may not coincide with each other. Since a boundary line of the execution screens is positioned on a foldable portion of the flexible display 140 (e.g., a portion of the flexible display 140 on the first hinge assembly 150 and/or a portion of the flexible display 140 on the second hinge assembly 160), visibility of the foldable portion on which the boundary line is positioned may be reduced.

Hereinafter, a hardware configuration of the electronic device 100 of FIG. 4A to FIG. 4B is illustrated and described in greater detail below with reference to FIG. 5.

FIG. 5 is a block diagram illustrating an example configuration of an electronic device 100 according to various example embodiments. Referring to FIG. 5, according to an embodiment, the electronic device 100 may include a processor (e.g., including processing circuitry) 510 and memory 520. The electronic device 100 may include a flexible display 140. The electronic device 100 may further include a sensor 530. The electronic device 100 may include a cover display 170. The processor 510 may be electrically and/or operatively coupled to the memory 520, the sensor 530, the flexible display 140, and/or the cover display 170. Electronic components being electrically coupled may include a state in which a wired signal path for transmission of a signal (or a connection for wireless communication) is established between the electronic components. Electronic components being operatively coupled may include a state in which the electronic components are directly coupled (or a state in which the electronic components are indirectly coupled) such that another electronic component is controlled by one electronic component among the electronic components.

The processor 510 of FIG. 5 may include various processing circuitry (e.g., processing circuitry and/or a core) for performing an operation (e.g., arithmetic operation and/or logical operation) on data. A binary code (e.g., an instruction) indicating the operation may be inputted to t he processor 510. The processor 510 may include a central processing unit (CPU), a graphic processing unit (GPU), a neural processing unit (NPU), or a combination thereof. The processor 510 may include, as processing circuitry for processing an operation on data, an arithmetic and logic unit (ALU), a floating point unit (FPU), and/or a field programmable gate array (FPGA). The processor 510 may include an application processor (AP) and/or a system on a chip (SoC). The processor 510 may have a structure (e.g., a multi-core structure such as a dual core, a quad core, a hexa core, or an octa core) for simultaneously loading (or fetching) a plurality of instructions. A function and/or an operation described with reference to the present disclosure may be performed individually or collectively (e.g., in any combination) by one or more processing circuitry included in the processor 510.

The memory 520 of FIG. 5 may include circuitry for storing data (or instructions) inputted to the processor 510 or outputted from the processor 510. The memory 520 may include a volatile memory such as random-access memory (RAM) and/or a non-volatile memory such as read-only memory (ROM). The non-volatile memory may be referred to as storage. The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multi media card (eMMC). The memory 520 may include one or more storage mediums (e.g., the above-described volatile memory and/or non-volatile memory) positioned in a distributed manner in the electronic device 100. The processor 510 of the electronic device 100 may perform a function and/or an operation indicated by the instructions by executing the instructions of the memory 520 in the electronic device 100. For example, when the electronic device 100 includes at least one processor, the at least one processor may be configured to execute the instructions collectively or individually.

A display including the flexible display 140 and/or the cover display 170 of FIG. 5 may include circuitry for visualizing information provided from the processor 510. The display may include a liquid crystal display (LCD), a plasma display panel (PDP), and/or light emitting diodes (LEDs). The LED may include an organic LED (OLED). The disclosure is not limited thereto, and the display may include electronic paper. A displaying region (or an active region) of the display may include a region, which is formed by pixels (e.g., activated pixels) of the display, from which light is emitted. The display may include a sensor (e.g., a touch sensor) for detecting an external object (e.g., a finger of a user) on the display. The sensor may be included in the display in a form of a panel (e.g., a touch sensor panel (TSP)).

The sensor 530 of FIG. 5 may include circuitry for generating and/or outputting electrical information processable by the processor 510 (or storable in the memory 520) from non-electrical information. For example, the sensor 530 may generate or output information associated with a state of the electronic device 100 (e.g., preset states and/or a shape of the electronic device 100 defined by a first angle and/or a second angle of a multi-foldable housing). For example, the sensor 530 may include a first sensor configured to detect a first angle between a first housing part (e.g., the first housing part 110 of FIG. 4A and/or FIG. 4B) and a second housing part (e.g., the second housing part 120 of FIG. 4A and/or FIG. 4B). For example, the sensor 530 may include a second sensor configured to detect a second angle between the second housing part and a third housing part (e.g., the third housing part 130 of FIG. 4A and/or FIG. 4B).

Referring to FIG. 5, as an example of a sensor generating information associated with a state of the electronic device 100, an inertial measurement unit (IMU) 532 and a Hall sensor 534 are illustrated. The IMU 532 may include an acceleration sensor, a gyro sensor, a geomagnetic sensor, or a combination thereof. Information generated from the IMU 532 may indicate a motion of the electronic device 100 based on 6 degrees of freedom (e.g., an x axis, roll-rotation around the x axis, a y axis, pitch-rotation around the y axis, a z axis, and yaw-rotation around the z axis). The Hall sensor 534 may include a combination of a magnet (e.g., a permanent magnet and/or an electromagnet) and a magnetic field sensor. The Hall sensor 534 may output information indicating an intensity of a magnetic field (e.g., a magnetic field generated from a magnet paired with the magnetic field sensor) detected by the magnetic field sensor. The information may be dependent on a positional relationship between the magnetic field sensor and the magnet.

In an embodiment, the processor 510 may identify a current state of the electronic device 100 from among preset states (e.g., an unfolded state, a folded state, and/or a sub-fold state) of the electronic device 100 using information outputted from the sensor 530. For example, in response to detecting the first angle and the second angle included within a preset angle range including 180° using the information, the processor 510 may determine that a state of a housing of the electronic device 100 corresponds to the unfolded state. While the housing of the electronic device 100 is in the unfolded state, the processor 510 may display, on the flexible display 140, an execution screen based on a program (e.g., a software application) executed by the processor 510. The software application (or an application) may include a set of instructions stored in the memory 520.

In an embodiment including the flexible display 140 positioned on the multi-foldable housing, the electronic device 100 may include information on a foldable portion formed in a displaying region of the flexible display 140 (e.g., a portion in which a crease may be formed according to folding and/or rotation of the multi-foldable housing). The information may be stored in the memory 520. Using the information, the processor 510 may determine sizes of a plurality of execution screens such that a boundary line between the plurality of execution screens is positioned on the foldable portion. The information may include coordinates of the foldable portion and/or dimensions (e.g., a width, a height, a position, a size, and/or an aspect ratio) of a logical display. Since the boundary line of the execution screens is positioned on the foldable portion, a crease of the foldable portion does not distort content included in the execution screens, and visual inconvenience due to the distortion may be reduced.

Hereinafter, an example operation of displaying execution screens on the flexible display 140, performed by the processor 510, is described in greater detail below with reference to FIG. 6.

FIG. 6 is a flowchart illustrating example operations of an electronic device according to various example embodiments. An operation of the electronic device described with reference to FIG. 6 may be performed by the electronic device 100 of FIG. 4A, FIG. 4B, and/or FIG. 5, and/or the processor 510 of FIG. 5. An order of the operations described with reference to FIG. 6 may be performed differently from an order of FIG. 6 according to an embodiment. For example, by the electronic device, the operations of FIG. 6 may be performed in an order reverse to the order of FIG. 6, or may be performed substantially simultaneously.

Referring to FIG. 6, in operation 610, according to an embodiment, the processor of the electronic device may receive an input for display of a multi-window. The processor may display, on a flexible display (e.g., the flexible display 140 of FIG. 4A and/or FIG. 4B), a visual object (e.g., a menu, an icon, a hyperlink, and/or a button) for receiving the input of the operation 610. The input of the operation 610 may include a gesture associated with the visual object (e.g., a hand gesture and/or a finger gesture performed on a display). The disclosure is not limited thereto, and the input of the operation 610 may include a voice input. The input of the operation 610 may be identified by an external object (e.g., a remote controller) spaced apart from the electronic device and/or the flexible display. The input of the operation 610 may be received while displaying one or more execution screens on the flexible display.

Referring to FIG. 6, in operation 620, according to an embodiment, a processor of the electronic device may identify a property (or properties) of a first execution screen that was displayed before receiving the input of the operation 610 and/or a second execution screen to be further displayed on the flexible display by the input of the operation 610. The property may be included in metadata (e.g., a preset file and/or a resource such as manifest.xml) of a software application associated with the first execution screen and/or the second execution screen. The property may be set by a list (e.g., a white-list) managed by an operating system (or a framework). The property of the operation 620 may be associated with an order of sizes of execution screens and/or a priority of the execution screens when displaying the multi-window. The property of the operation 620 may be associated with a group of the software application, or content (e.g., a video, a text, a web page, and/or a document) to be provided through the software application (or provided through an execution screen provided by the software application).

Referring to FIG. 6, in operation 630, according to an embodiment, the processor of the electronic device may display the first execution screen and the second execution screen using the identified property (or properties), through each of portions of the flexible display non-uniformly divided by one of the foldable portions of the flexible display. As described above with reference to FIG. 4A and/or FIG. 4B, in an embodiment in which the flexible display is disposed on front sides of three housing parts (e.g., the first housing part 110, the second housing part 120, and the third housing part 130 of FIG. 4A and/or FIG. 4B), the foldable portions including creases may be spaced apart from a center of the flexible display. For example, when the processor displays execution screens having equivalent sizes on the flexible display, content of the execution screens may be positioned on creases of the flexible display. Since the processor performs the operation 630, a boundary line between the execution screens may be positioned on one of the foldable portions. For example, content included in the execution screens may not be positioned in the foldable portion on which the boundary line is positioned, and distortion of the content due to the creases of the foldable portion may be prevented and/or reduced.

The processor may non-uniformly determine sizes of the execution screens using the property of the operation 620. For example, the property may include a first property (or a first group or a first category) for displaying an execution screen in a relatively large size. For example, the property may include a second property (or a second group or a second category) for displaying an execution screen in a relatively small size. For example, the first property may be set to include a software application for playing an image and/or a video (e.g., a video player, a gallery application, or an over the top (OTT) application), a software application for generating (or obtaining or capturing) an image and/or a video (e.g., a camera application), a software application for generating content including a document and/or an image (e.g., a note application), and/or a software application for editing an image and/or a video. For example, the second property may be set to include a software application such as a web browser and/or a messenger. The disclosure is not limited thereto.

For example, when the first execution screen has the first property and the second execution screen has the second property, the processor may determine a size of the first execution screen to be greater than a size of the second execution screen. In an embodiment including two foldable portions dividing the displaying region of the flexible display into three equal parts as described above with reference to FIG. 4A and/or FIG. 4B, the processor may determine a ratio between the size of the first execution screen and the size of the second execution screen as 2:1 (e.g., the state 402 of FIG. 4B). Due to the ratio between the sizes, a boundary line of the first execution screen and the second execution screen may be formed on one of the foldable portions.

For example, when two execution screens (or software applications respectively corresponding to the two execution screens) have the same property, the processor may determine a size of an execution screen (e.g., the first execution screen) displayed before receiving the input of the operation 610 to be a size greater than a size of another execution screen (e.g., the second execution screen). The disclosure is not limited thereto, and the processor may determine sizes of the two execution screens according to a setting value adjustable by a user. For example, the processor may determine the sizes of the two execution screens according to an order in which the two execution screens are displayed and/or the setting value. For example, when properties of the two execution screens are the same and the user sets to emphasize the second execution screen to be additionally displayed, the processor may determine a ratio between the size of the first execution screen and the size of the second execution screen as 1:2.

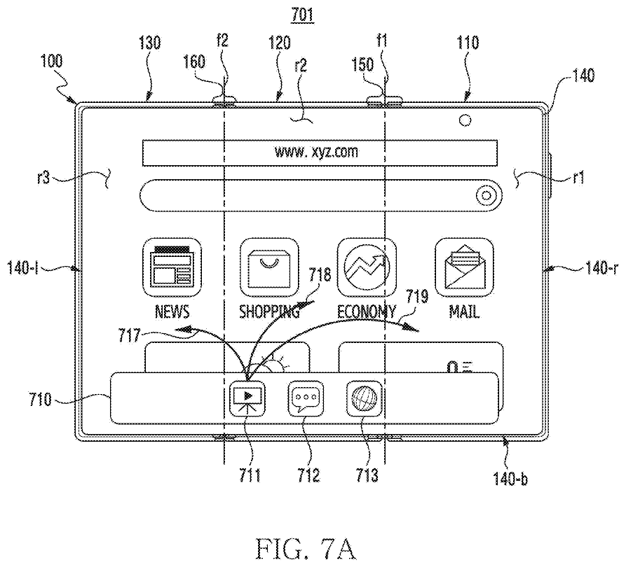

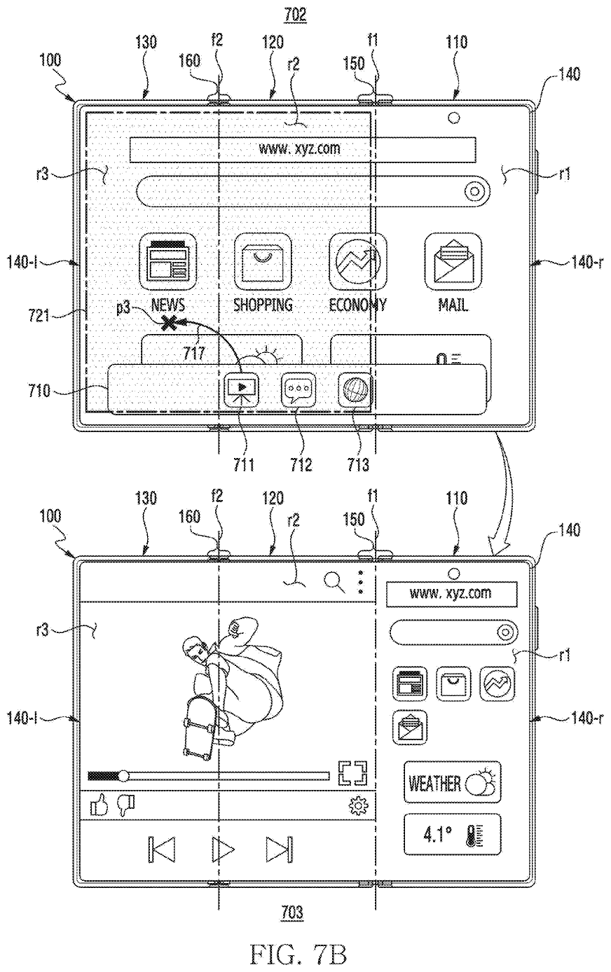

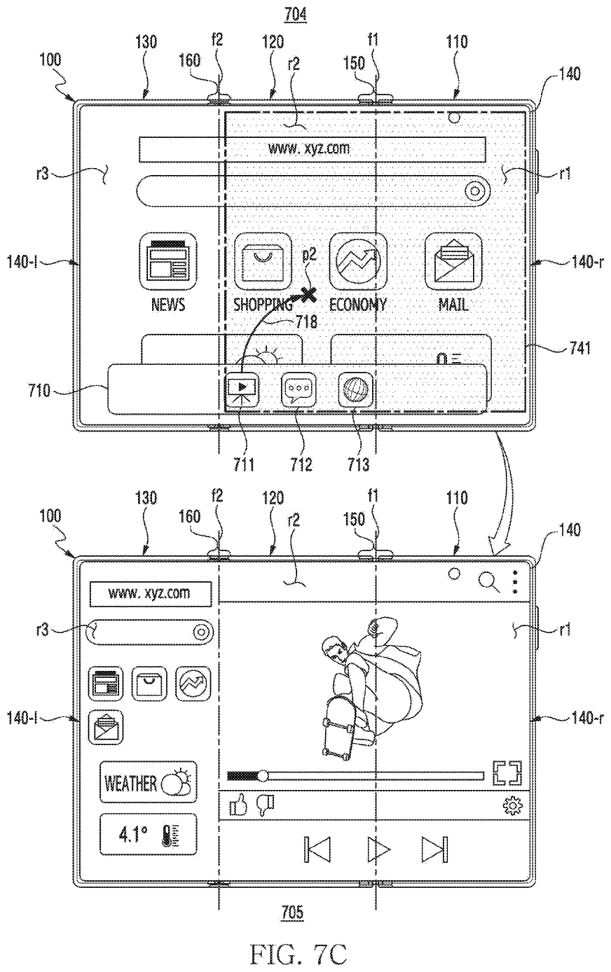

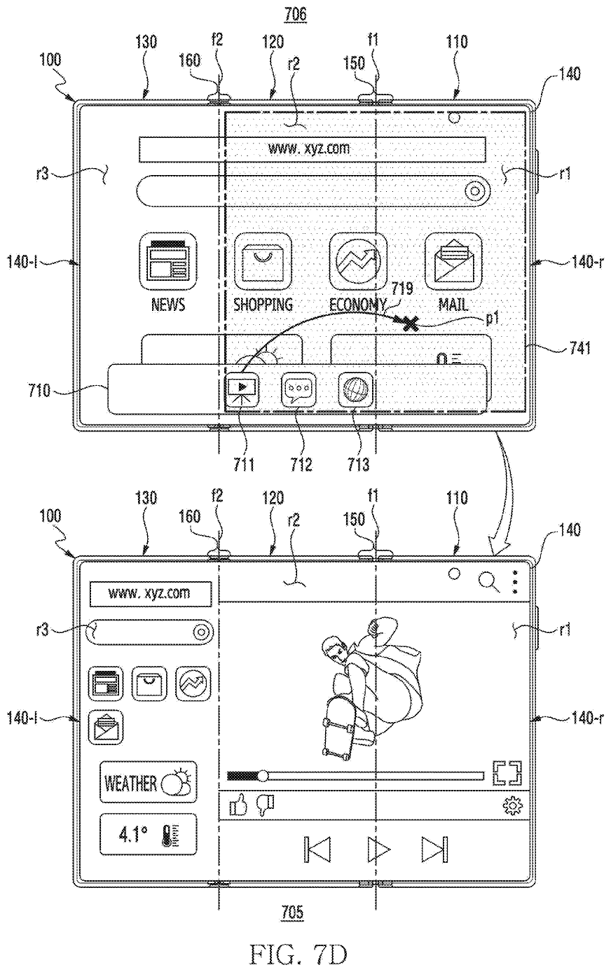

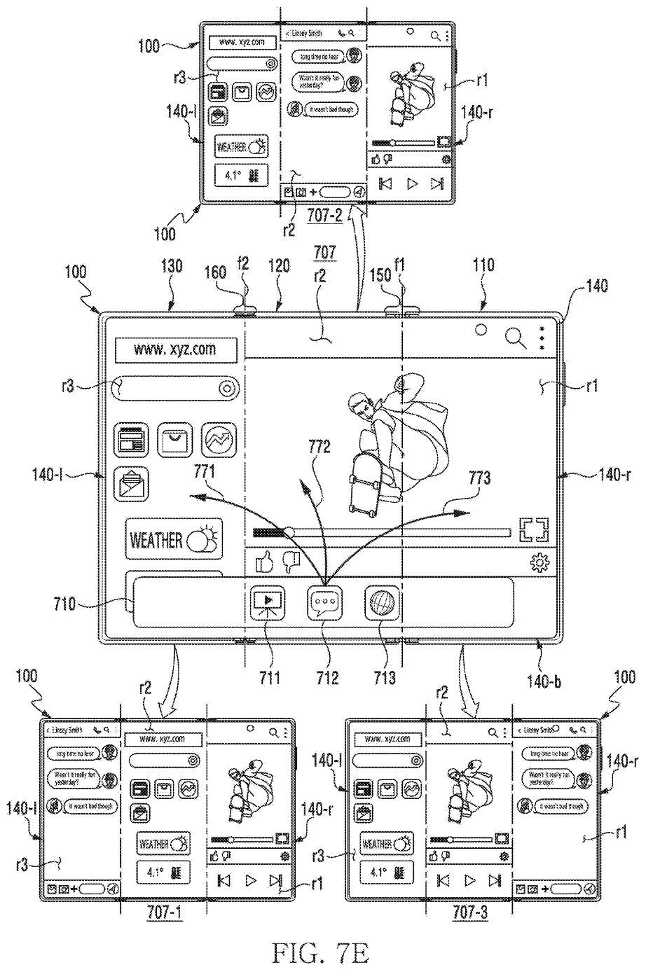

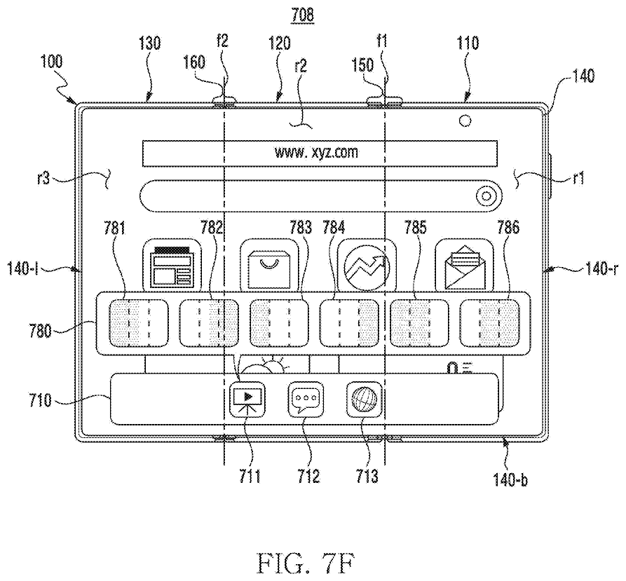

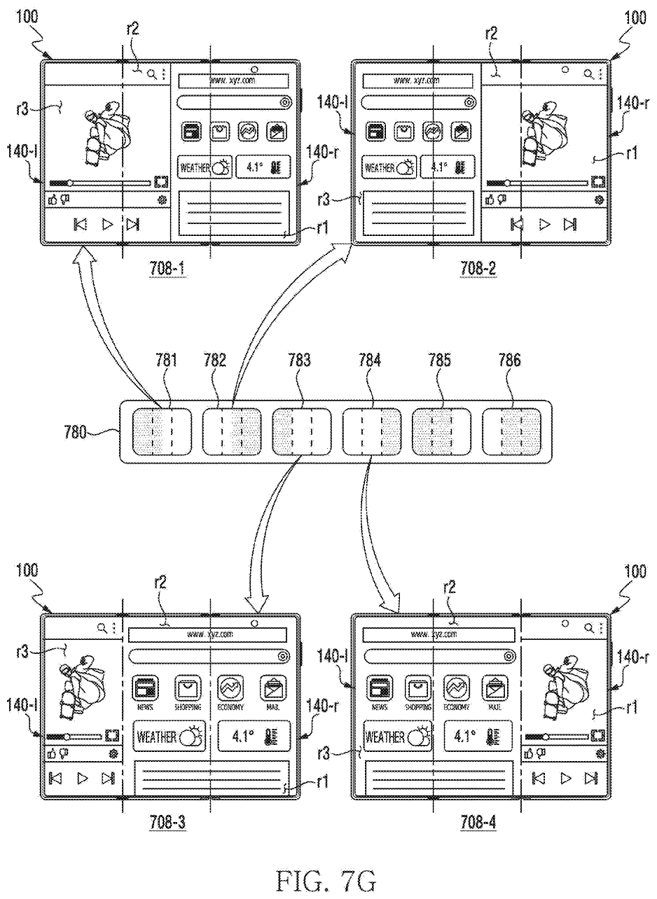

Hereinafter, various example states of the electronic device and/or the processor performing the operation of FIG. 6 are described in greater detail with reference to FIG. 7A to FIG. 7G.

FIG. 7A, FIG. 7B, FIG. 7C, FIG. 7D, FIG. 7E, FIG. 7F, and FIG. 7G are diagrams illustrating example states 701, 702, 703, 704, 705, 706, 707, and 708 of an electronic device 100 displaying an execution screen according to an input for a visual object such as an icon (e.g., icons 711, 712, and 713) according to various example embodiments. The electronic device 100 of FIG. 4A, FIG. 4B, and/or FIG. 5, and/or the processor 510 of FIG. 5 may perform an operation of the electronic device 100 described with reference to FIG. 7A to FIG. 7G. The operation of the electronic device 100 described with reference to FIG. 7A to FIG. 7G may be associated with at least one of the operations of FIG. 6.

Referring to FIG. 7A, the example state 701 of the electronic device 100 displaying a first execution screen on a flexible display 140 is illustrated. In the state 701, the electronic device 100 may display, on the flexible display 140, the first execution screen having a size of an entire displaying region (e.g., a first portion r1, a second portion r2, and a third portion r3) of the flexible display 140. For example, the electronic device 100 may display the first execution screen associated with a first application. Although the example state 701 of the electronic device 100 displaying the first execution screen based on execution of a web browser is illustrated, the disclosure is not limited thereto.

Referring to FIG. 7A, in the state 701 included in an unfolded state, the electronic device 100 may display one or more execution screens using the entire displaying region of the flexible display 140. In the state 701, the electronic device 100 may support a multi-window according to a layout linked to foldable portions of the flexible display 140 formed on hinge assemblies (e.g., a first hinge assembly 150 and a second hinge assembly 160). In the state 701 displaying a single execution screen (e.g., the first execution screen) using the entire displaying region of the flexible display 140, the electronic device 100 may display a visual object for adding an execution screen to be displayed through the flexible display 140. Referring to FIG. 7A, the electronic device 100 may display a visual object 710 referred to as an application tray (or an app tray), which is an example of the visual object. The visual object 710 may be referred to as an application list (or an app list), a dock region, and/or a dock menu. The visual object 710 may be referred to as a task bar and/or an edge panel.

For example, the visual object 710 may be always displayed in the unfolded state (e.g., the state 701). For example, the visual object 710 may be conditionally displayed in response to a preset gesture. The electronic device 100 may display the visual object 710 in response to a drag gesture (e.g., a swipe gesture and/or a swipe-up gesture) starting from one point on the flexible display 140 adjacent to one periphery (e.g., a lower periphery 140-b) of the flexible display 140 and moving in a direction away from the periphery. In response to the drag gesture, the electronic device 100 may play an animation such as the visual object 710 moving from the periphery. The disclosure is not limited thereto, and the electronic device 100 may display the visual object 710 in response to another gesture (e.g., a double-tap gesture for a preset portion of the flexible display 140). Although an embodiment of displaying the visual object 710 at a position adjacent to the lower periphery 140-b is illustrated, a position of the visual object 710 is not limited thereto.

The electronic device 100 may display, in the visual object 710, visual objects (e.g., the icons 711, 712, and 713) respectively representing software applications installed in the electronic device 100. For example, the electronic device 100 may display at least one icon (e.g., the icons 711, 712, and 713) associated with at least one application. Although an operation of the electronic device 100 receiving an input based on an icon is described, the disclosure is not limited thereto. For example, the electronic device 100 may receive an input for adding an execution screen to be displayed through the flexible display 140 through a text, a link, and/or a menu representing a software application. In the visual object 710, the icons 711, 712, and 713 may be arranged or distinguished according to properties of software applications respectively corresponding to the icons 711, 712, and 713.

Through the visual object 710, the electronic device 100 may receive an input indicating execution of a software application. For example, the electronic device 100 receiving an input (e.g., an input based on a tap gesture) that indicates selecting one icon (e.g., one of the icons 711, 712, and 713) included in the visual object 710 may execute a software application corresponding to the input, and may display, on the flexible display 140, an execution screen provided from the executed software application. In response to the input, the electronic device 100 may display, in the entire displaying region of the flexible display 140, the execution screen provided from the executed software application. For example, the first execution screen displayed through the entire displaying region of the flexible display 140 may be replaced with the execution screen provided from the executed software application.

Through the visual object 710, the electronic device 100 may receive an input for further displaying another execution screen together with the first execution screen being displayed on the flexible display 140. The input may be received while a state of a housing of the electronic device 100 corresponds to the unfolded state. For example, the electronic device 100 may receive the input based on a drag gesture moving the icon 711 of the visual object 710 (e.g., an icon representing a video playback application for streaming a video). For example, the input may include an input for moving at least one icon displayed through the visual object 710 to a defined (e.g., preset) portion of the flexible display 140. The defined portion may include one of a first boundary positioned on the first hinge assembly 150 and parallel to a direction in which the first hinge assembly 150 is extended, or a second boundary positioned on the second hinge assembly 160 and parallel to a direction in which the second hinge assembly 160 is extended.

Referring to FIG. 7A, example paths 717, 718, and 719 of a gesture for dragging the icon 711 are illustrated. The gesture for dragging the icon 711 along one of the paths 717, 718, and 719 may be detected by a motion of a finger and/or a stylus (or a pen) contacted on the flexible display 140 of the electronic device 100. For example, in order to detect the motion of the stylus, the electronic device 100 and/or the flexible display 140 may further include a sensor (e.g., a digitizer) for detecting the motion of the stylus. For example, using a wireless signal received from the stylus, the electronic device 100 may detect the motion from the stylus. The electronic device 100 receiving an input for dragging the icon along the path 717 may switch from the state 701 of FIG. 7A to the state 702 of FIG. 7B. The electronic device 100 receiving an input for dragging the icon 711 along the path 718 may switch from the state 701 of FIG. 7A to the state 704 of FIG. 7C. The electronic device 100 receiving an input for dragging the icon 711 along the path 719 may switch from the state 701 of FIG. 7A to the state 706 of FIG. 7D. The electronic device 100 receiving an input for dragging the icon 711 associated with a second execution screen in the state 701 displaying the first execution screen may determine a layout of the first execution screen and the second execution screen according to the path (e.g., the paths 717, 718, and 719) of the icon 711 moved by the input.

Referring to FIG. 7B, in the state 702 in which the input for dragging the icon 711 along the path 717 is being received, the electronic device 100 may display a visual object 721 for guiding a position and/or a size of the second execution screen corresponding to the icon 711. The visual object 721 may be overlappingly displayed on the first execution screen displayed on the flexible display 140. The visual object 721 may include a translucent shape (e.g., having a preset transparency) having a quadrangular form. The visual object 721 may be referred to as a visual affordance. For example, the visual object 721 may be displayed to guide the defined portion of the flexible display 140 in which the second execution screen corresponding to the icon 711 is to be displayed.

For example, when receiving the input for dragging the icon 711 for providing the second execution screen having a first property set to display an execution screen having a relatively large size, the electronic device 100 may display the visual object 721 indicating that two portions among portions (e.g., the first portion r1, the second portion r2, and the third portion r3) of the flexible display 140 divided by folding axes (e.g., a first folding axis f1 and a second folding axis f2) are allocated to the second execution screen. Referring to FIG. 7B, while receiving the input for dragging the icon 711, along the path 717, to the third portion r3 of the flexible display 140 positioned on a third housing part 130, the electronic device 100 may display the visual object 721 having a form covering the third portion r3 and the second portion r2 next to the third portion r3. For example, when the input for dragging the icon 711 along the path 717 is terminated, the electronic device 100 may notify that the second execution screen based on a position and/or a size of the visual object 721 is scheduled to be displayed together with the first execution screen.

In the example state 702 of FIG. 7B, when the input for dragging the icon 711 ceases at a point p3 in the third portion r3, the electronic device 100 may switch to the state 703. For example, based on receiving the input for dragging the icon 711 to the third portion r3 of the flexible display 140, the electronic device 100 may switch from one state among the states 701 and 702 to the state 703. Referring to the example state 703 of FIG. 7B, based on receiving the input for dragging the icon 711 to the third portion r3, the electronic device 100 may display, in the first portion r1 of the flexible display 140, the first execution screen reduced according to a size of the first portion r1. In the state 703, based on receiving the input for dragging the icon 711 to the third portion r3, the electronic device 100 may display the second execution screen in the second portion r2 and the third portion r3. For example, the electronic device 100 may display the second execution screen associated with the input in the defined portion of the flexible display 140 and may display the first execution screen by moving to a remaining portion of the flexible display 140 different from the defined portion. For example, the electronic device 100 may display the first execution screen by moving to a left side or a right side of the flexible display 140.

Referring to FIG. 7B, in the state 703 displaying, together with the first execution screen, the second execution screen based on execution of a software application corresponding to the icon 711, a boundary line of the first execution screen and the second execution screen may be positioned parallel to the first folding axis f1 on a foldable portion of the flexible display 140 adjacent to the first folding axis f1. For example, the boundary line may be positioned on a crease formed by the first hinge assembly 150 folded or rotated based on the first folding axis f1. In the state 703, a user viewing the flexible display 140 may view content of the first execution screen and the second execution screen independently of the crease positioned on the boundary line. For example, in the state 703, the electronic device 100 may display the second execution screen in a defined portion of the flexible display 140 positioned on a second housing part 120 and the third housing part 130 divided by the first folding axis f1, and may display the first execution screen by moving to a remaining portion of the flexible display 140 (or a right portion of the flexible display 140) positioned on a first housing part 110.

Referring to FIG. 7C, in the state 704 in which the input for dragging the icon 711 along the path 718 is being received, the electronic device 100 may display a visual object 741 for guiding a position and/or a size of the second execution screen corresponding to the icon 711. The electronic device 100 may display the visual object 741 similarly to the visual object 721 of FIG. 7B. The visual object 741 corresponding to the second execution screen provided from a software application for playing a video may have a size occupying two portions (e.g., the first portion r1 and the second portion r2) of the flexible display 140. Referring to FIG. 7C, while receiving the input for dragging the icon 711 along the path 718 to the second portion r2 of the flexible display 140 positioned on the second housing part 120, the electronic device 100 may display the visual object 741 having a form occupying the second portion r2 and the first portion r1 next to the second portion r2.

In the example state 704 of FIG. 7C, when the input for dragging the icon 711 ceases at a point p2 in the second portion r2, the electronic device 100 may switch to the state 705. Referring to the example state 705 of FIG. 7C, in response to receiving the input for dragging the icon 711 to the second portion r2, the electronic device 100 may display, in the first portion r1 and the second portion r2 of the flexible display 140, the second execution screen associated with the icon 711. In response to the input, the electronic device 100 may display, in the third portion r3 of the flexible display 140, the first execution screen reduced according to a size of the third portion r3.

Referring to FIG. 7C, in the state 705 simultaneously displaying the second execution screen associated with the icon 711 and the first execution screen, a boundary line of the first execution screen and the second execution screen may be formed on a foldable portion of the flexible display 140 adjacent to the second folding axis f2. The boundary line may have a form of a straight line parallel to the second folding axis f2. For example, the boundary line may be positioned on a crease formed by the second hinge assembly 160 folded or rotated based on the second folding axis f2. In the state 705, the user viewing the flexible display 140 may view content of the first execution screen and the second execution screen independently of the crease positioned on the boundary line.

Although the state 704 displaying the visual object 741 while receiving the input for dragging the icon 711 along the path 718 is illustrated, the disclosure is not limited thereto. For example, when receiving the input for dragging the icon 711 to the second portion r2 along the path 718, the electronic device 100 may display a visual object indicating that the second execution screen may not be added to the second portion r2.

Referring to FIG. 7D, in the state 706 in which the input for dragging the icon 711 along the path 719 is being received, the electronic device 100 may display the visual object 741 for guiding the position and/or the size of the second execution screen corresponding to the icon 711. Similarly to the state 704 of FIG. 7C, the electronic device 100 may display the visual object 741 having a form and a position occupying the first portion r1 and the second portion r2 of the flexible display 140.

Referring to the state 704 of FIG. 7C and/or the state 705 of FIG. 7D, the electronic device 100 may display the second execution screen in a defined portion of the flexible display 140 positioned on the first housing part 110 and the second housing part 120 divided by the second folding axis f2, and may display the first execution screen by moving the first execution screen to a remaining portion of the flexible display 140 (or a left portion of the flexible display 140) positioned on the third housing part 130.

When further displaying the second execution screen together with the first execution screen being displayed on the flexible display 140, the electronic device 100 may display the second execution screen to a right side of the first execution screen such that the second execution screen is displayed at a position adjacent to a right hand (e.g., a position adjacent to a right periphery 140-r of the flexible display 140). In order to assist interaction between the second execution screen and the right hand, the second execution screen to be additionally displayed by the input may be configured to be displayed to the right side of the first execution screen. When receiving an input different from an explicit input for displaying the second execution screen to a left side of the first execution screen, such as the input for moving the icon 711 along the path 717 of FIG. 7B, the electronic device 100 may switch to a state guiding displaying of the second execution screen to the right side of the first execution screen, as in the state 704 of FIG. 7C and/or the state 706 of FIG. 7D.

In the example state 706 of FIG. 7D, when the input for dragging the icon 711 ceases at a point p1 in the first portion r1, the electronic device 100 may switch from the state 706 to the state 705 of FIG. 7D. The state 705 of FIG. 7D may correspond to the state 705 of FIG. 7C. For example, in response to the input, the electronic device 100 may display, in the third portion r3 of the flexible display 140, the first execution screen reduced according to the size of the third portion r3, and may display, in the first portion r1 and the second portion r2, the second execution screen.

As described above with reference to FIG. 7A to FIG. 7D, the electronic device 100 may receive an input (e.g., an input based on a drag gesture) for allocating or mapping a visual object such as the icon 711 (e.g., a visual object corresponding to a software application) and portions of the flexible display 140. In response to the input, the electronic device 100 may display the second execution screen associated with the input together with the first execution screen being displayed at a time point of receiving the input. For example, referring to FIG. 7C to FIG. 7D, the electronic device 100 receiving the input for dragging the icon 711 to the first portion r1 of the flexible display 140 positioned on the first housing part 110 or to the second portion r2 of the flexible display 140 positioned on the second housing part 120 may display, in the first portion r1 and the second portion r2, the second execution screen, and may display, in the third portion r3, the first execution screen having a size reduced according to the size of the third portion r3.

Referring to FIG. 7E, the example state 707 of the electronic device 100 displaying two execution screens, as in the state 705 of FIG. 7C to FIG. 7D, is illustrated. In the state 707, the electronic device 100 may further receive an input for adding a third execution screen. The input may include a drag gesture moving the icon 712 associated with the third execution screen (e.g., the icon 712 corresponding to a messenger application). Referring to FIG. 7E, example paths 771, 772, and 773 of a gesture for dragging the icon 712 are illustrated.

In the state 707 displaying the first execution screen associated with a web browser in the first portion r1 and displaying the second execution screen associated with a video playback application in the second portion r2 and the third portion r3, the electronic device 100 receiving an input for dragging the icon 712 along the path 771 may switch to a state 707-1 of FIG. 7E. In response to an input for dragging the icon 712 along the path 772, the electronic device 100 may switch from the state 707 to a state 707-2 of FIG. 7E. In response to an input for dragging the icon 712 along the path 773, the electronic device 100 may switch from the state 707 to a state 707-3 of FIG. 7E.

Referring to the states 707-1, 707-2, and 707-3 of FIG. 7E, the electronic device 100 may display the first execution screen, the second execution screen, and the third execution screen having foldable portions of the flexible display 140 formed by hinge assemblies (e.g., the first hinge assembly 150 and/or the second hinge assembly 160) as boundary lines. Since the boundary lines of the first execution screen, the second execution screen, and the third execution screen are positioned in the foldable portions, creases formed on the foldable portions may be prevented/reduced from distorting content of the first execution screen, the second execution screen, and the third execution screen.

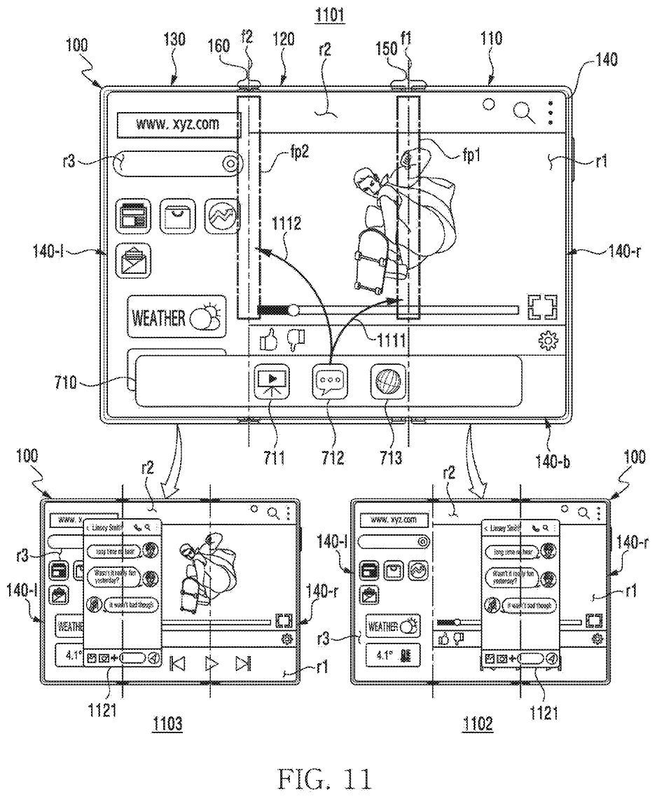

In an embodiment, an order of the first execution screen, the second execution screen, and the third execution screen displayed in the flexible display 140 may be associated with the input received in the state 707. For example, the order of the first execution screen, the second execution screen, and the third execution screen may be determined according to an end point of the drag gesture for moving the icon 712. Although the example states 707-1, 707-2, and 707-3 in which the first execution screen, the second execution screen, and the third execution screen are displayed according to a layout of PBP are described, the disclosure is not limited thereto, and as described later with reference to FIG. 11, the electronic device 100 may display the execution screens according to a layout of PIP.

Referring to the state 707-1 of FIG. 7E, the electronic device 100 receiving the input for moving the icon 712 to the third portion r3 along the path 771 may display, in the third portion r3, the third execution screen corresponding to the icon 712. In the state 707-1, the electronic device 100 may display, in the second portion r2 positioned next to the third portion r3, the first execution screen that was displayed in the third portion r3 before the state 707-1. In the state 707-1, the electronic device 100 may display, in the first portion r1, the second execution screen that occupied the first portion r1 and the second portion r2 before the state 707-1. For example, the electronic device 100 may display the second execution screen reduced according to the size of the first portion r1.

Referring to the state 707-2 of FIG. 7E, the electronic device 100 receiving the input for moving the icon 712 to the second portion r2 along the path 772 may display, in the second portion r2, the third execution screen corresponding to the icon 712. In the state 707-2, the electronic device 100 may maintain displaying, in the third portion r3, the first execution screen that was displayed in the third portion r3 before the state 707-2. In the state 707-2, the electronic device 100 may display, in the first portion r1, the second execution screen that occupied the first portion r1 and the second portion r2 before the state 707-1.

Referring to the state 707-3 of FIG. 7E, the electronic device 100 receiving the input for moving the icon 712 to the first portion r1 along the path 773 may display, in the first portion r1, the third execution screen. In the state 707-3, the electronic device 100 may maintain displaying, in the third portion r3, the first execution screen that was displayed in the third portion r3 before the state 707-3. In the state 707-3, the electronic device 100 may display, in the second portion r2, the second execution screen that occupied the first portion r1 and the second portion r2 before the state 707-1. For example, the electronic device 100 may display the second execution screen reduced according to a size of the second portion r2.

Referring to the example state 708 of FIG. 7F, the electronic device 100 may display a menu 780 including selectable options for a layout of the second execution screen to be displayed together with the first execution screen being displayed on the flexible display 140. The electronic device 100 may switch to the state 708 displaying the menu 780 in response to a double-tap gesture for the icon 711. Although the double-tap gesture is illustrated as an input for displaying the menu 780, the disclosure is not limited thereto. The menu 780 may be referred to as a guide menu.

Referring to FIG. 7F, through the menu 780, the electronic device 100 may display the first execution screen being displayed on the flexible display 140 and visual objects 781, 782, 783, 784, 785, and 786 respectively corresponding to options of a layout of the first execution screen corresponding to the icon 711. The options may be distinguished according to positions, sizes, and/or a ratio between the sizes of the first execution screen and the second execution screen. Although the example state 708 of the electronic device 100 displaying the visual objects 781, 782, 783, 784, 785, and 786 respectively corresponding to six options is illustrated, the disclosure is not limited thereto. The electronic device 100 may provide a portion of the six options, or may further provide an option different from the six options.

Each of the example visual objects 781, 782, 783, 784, 785, and 786 of FIG. 7F may include a quadrangle of a straight line indicating a shape of the flexible display 140 and dotted lines representing folding axes (e.g., the first folding axis f1 and the second folding axis f2). Each of the example visual objects 781, 782, 783, 784, 785, and 786 of FIG. 7F may include a figure (e.g., a quadrangle displayed with dots and filled with a preset color) indicating a position of the second execution screen to be additionally displayed on the flexible display 140 by an input that indicates selecting a visual object. A shape, a size, and/or a position of the figure included in each of the visual objects 781, 782, 783, 784, 785, and 786 may indicate a shape, a size, and/or a position of the second execution screen to be displayed on the flexible display 140.

In the state 708 of FIG. 7F, in response to an input that indicates selecting one of the visual objects 781, 782, 783, 784, 785, and 786, the electronic device 100 may switch to another state displaying both the first execution screen and the second execution screen having a layout associated with (or mapped to) the visual object selected by the input.

Referring to FIG. 7G, in response to an input that indicates selecting the visual object 781, the electronic device 100 may switch to a state 708-1. In the state 708-1, the electronic device 100 may display the second execution screen in a left half of a displaying region of the flexible display 140 and may display the first execution screen in a right half of the displaying region. In the state 708-1, the electronic device 100 may respectively display the first execution screen and the second execution screen in portions equally dividing the flexible display 140.

Referring to FIG. 7G, in response to an input that indicates selecting the visual object 782, the electronic device 100 may switch to a state 708-2. In the state 708-2, the electronic device 100 may display the first execution screen in the left half of the displaying region of the flexible display 140 and may display the second execution screen in the right half of the displaying region. In the state 708-2, similarly to the state 708-1, the electronic device 100 may respectively display the first execution screen and the second execution screen in portions equally dividing the flexible display 140.

Referring to FIG. 7G, in the visual objects 781 and 782 respectively corresponding to the states 708-1 and 708-2, a quadrangle representing the second execution screen may have a size of half of a quadrangle representing the flexible display 140. In the visual objects 781 and 782, positions of the quadrangle representing the second execution screen may indicate positions of the second execution screen to be disposed on the flexible display 140 in each of the states 708-1 and 708-2.

Referring to FIG. 7G, in response to an input that indicates selecting the visual object 783, the electronic device 100 may switch to a state 708-3. In the state 708-3, the electronic device 100 may display the second execution screen in the third portion r3 of the flexible display 140 and may display the first execution screen in a combination of the first portion r1 and the second portion r2 of the flexible display 140. In the state 708-2, a ratio of sizes of the first execution screen and the second execution screen may be 2:1.

Referring to FIG. 7G, in response to an input that indicates selecting the visual object 784, the electronic device 100 may switch to a state 708-4. In the state 708-4, the electronic device 100 may display the second execution screen in the first portion r1 of the flexible display 140 and may display the first execution screen in a combination of the second portion r2 and the third portion r3 of the flexible display 140. In the state 708-4, a ratio of sizes of the first execution screen and the second execution screen may be 2:1, similarly to the state 708-3.

Referring to FIG. 7G, in the visual objects 783 and 784 respectively corresponding to the states 708-3 and 708-4, a quadrangle representing the second execution screen may have a size of ⅓ of the quadrangle representing the flexible display 140. In the visual objects 783 and 784, positions of the quadrangle representing the second execution screen may indicate positions of the second execution screen to be disposed on the flexible display 140 in each of the states 708-3 and 708-4.

The electronic device 100 displaying the menu 780 of FIG. 7G may switch to the state 703 of FIG. 7B in response to an input that indicates selecting the visual object 785 in the menu 780. For example, the electronic device 100 may display the second execution screen in a combination of the second portion r2 and the third portion r3 of the flexible display 140 and may display the first execution screen on the first portion r1. In response to an input that indicates selecting the visual object 786 in the menu 780, the electronic device 100 may switch to the state 705 of FIG. 7C and/or FIG. 7D. For example, the electronic device 100 may display the second execution screen in a combination of the first portion r1 and the second portion r2 of the flexible display 140 and may display the first execution screen on the third portion r3.

As described above, the electronic device 100 receiving an input associated with the second execution screen of a software application of a preset property (e.g., a first property and/or a first preset category) may display the second execution screen occupying at least two portions among the first portion r1, the second portion r2, and the third portion r3. Together with the second execution screen occupying the two portions, the electronic device 100 may display the first execution screen reduced according to a size of a single portion. The disclosure is not limited thereto, and the electronic device 100 receiving an input associated with the third execution screen of a software application of another property (e.g., a second property and/or a second preset category) may display the second execution screen in one portion among the first portion r1 and the third portion r3. Together with the second execution screen occupying the single portion, the electronic device 100 may display the first execution screen in all of remaining two portions.

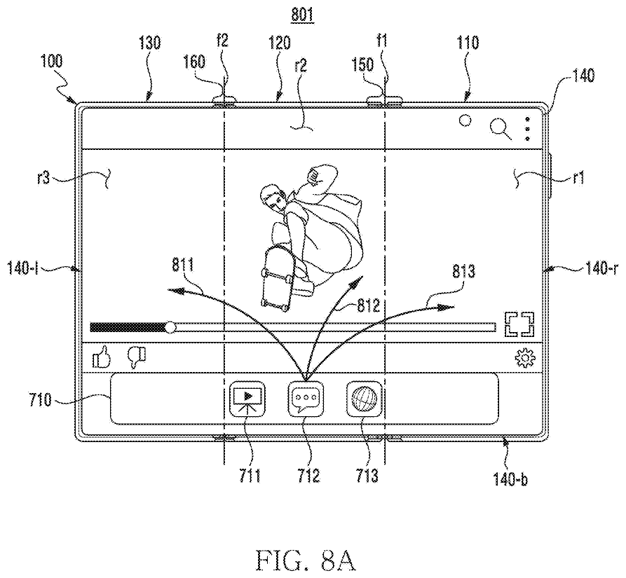

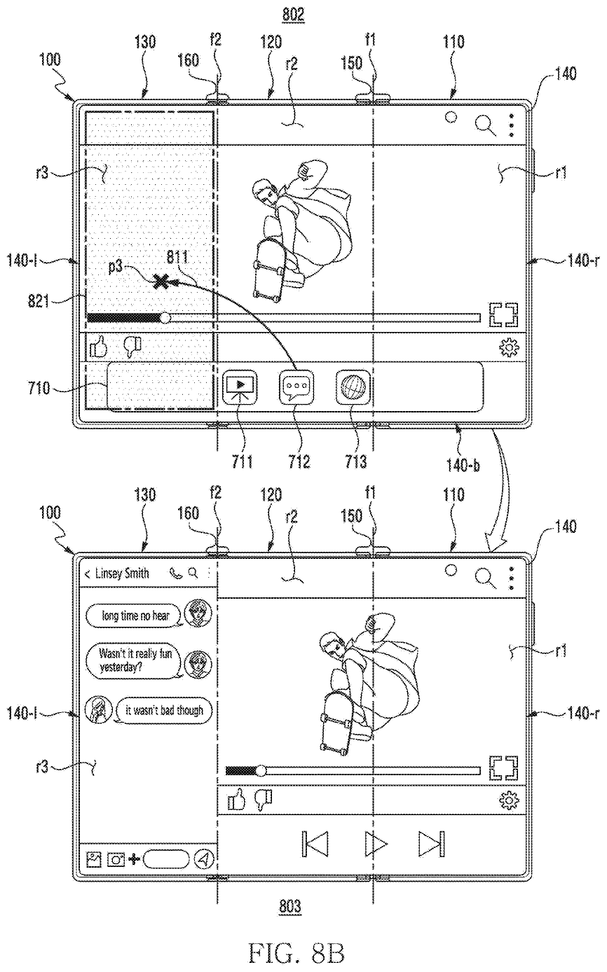

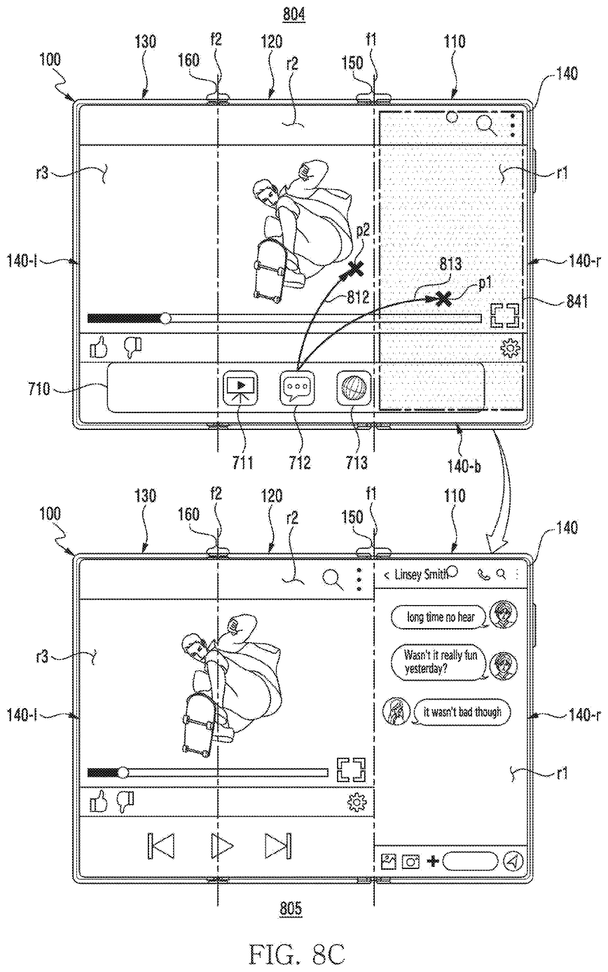

Hereinafter, with reference to FIGS. 8A, 8B and 8C, an example operation of the electronic device 100 receiving an input for displaying the third execution screen of the another property is described in greater detail.

FIG. 8A, FIG. 8B, and FIG. 8C are diagrams illustrating example states 801, 802, 803, 804, and 805 of an electronic device 100 displaying an execution screen according to an input for a visual object such as an icon (e.g., icons 711, 712, and 713) according to various example embodiments. The electronic device 100 of FIG. 4A, FIG. 4B, and/or FIG. 5, and/or the processor 510 of FIG. 5 may perform an operation of the electronic device 100 described with reference to FIG. 8A to FIG. 8C. The operation of the electronic device 100 described with reference to FIG. 8A to FIG. 8C may be associated with at least one of the operations of FIG. 6.

Referring to FIG. 8A, the example state 801 of the electronic device 100 displaying, on a flexible display 140, a first execution screen provided from a video playback application is illustrated. In the state 801 included in an unfolded state, the electronic device 100 may display the first execution screen in an entire displaying region of the unfolded flexible display 140. In the state 801 displaying the first execution screen, the electronic device 100 may receive an input for further displaying a second execution screen. The input may be received through a visual object 710 displayed overlappingly on the first execution screen.

Through the visual object 710, the electronic device 100 may receive an input for changing, adding, and/or replacing an execution screen displayed on the flexible display 140. For example, the electronic device 100 detecting a tap gesture for the icon 712 may execute a software application based on the icon 712 and may display, in the entire displaying region of the flexible display 140, the second execution screen provided from the executed software application. For example, the electronic device 100 detecting a double-tap gesture for the icon 712 may display a menu (e.g., the visual object 780 of FIG. 7F and/or FIG. 7G) including an option for adjusting a layout of the second execution screen and the first execution screen.

The electronic device 100 may receive an input for moving the icon 712 to the outside of the visual object 710. Referring to FIG. 8A, as examples of the input, example paths 811, 812, and 813 of drag gestures performed to move the icon 712 are illustrated. The electronic device 100 receiving an input for dragging the icon 712 along the path 811 may switch from the state 801 of FIG. 8A to the state 802 of FIG. 8B. The electronic device 100 receiving an input for dragging the icon 712 along one of the paths 812 and 813 may switch from the state 801 of FIG. 8A to the state 804 of FIG. 8C. According to a path (e.g., the paths 811, 812, and 813) of the icon 712 moved based on the input, the electronic device 100 may determine the layout of the first execution screen and the second execution screen.

Referring to FIG. 8B, in the state 802 in which the input for dragging the icon 712 along the path 811 is being received, the electronic device 100 may display a visual object 821 for guiding a position and/or a size of the second execution screen corresponding to the icon 712. Similarly to the visual object 721 and/or the visual object 741 of FIG. 7B, the visual object 821 may be displayed to preannounce the position and/or the size of the second execution screen.

For example, when receiving an input for dragging the icon 712 for providing the second execution screen having a second property set to display an execution screen having a relatively small size, the electronic device 100 may display the visual object 821 indicating that one portion among portions (e.g., a first portion r1, a second portion r2, and a third portion r3) of the flexible display 140 divided by folding axes (e.g., a first folding axis f1 and a second folding axis f2) is used for displaying the second execution screen. In the example state 802 of FIG. 8B, the electronic device 100 detecting the icon 712 moved to the third portion r3 along the path 811 may display, in the third portion r3 among the portions of the flexible display 140, the visual object 821 having a shape and/or a size of the third portion r3.

In the state 802 of FIG. 8B, when an input for dragging the icon 712 ceases at a point p3 in the third portion r3, the electronic device 100 may switch to the state 803. For example, in response to an input that indicates moving the icon 712 to the third portion r3, the electronic device 100 may switch from one state among the states 801 and 802 to the state 803. Referring to the example state 803 of FIG. 8B, the electronic device 100 receiving the input that indicates moving the icon 712 to the third portion r3 may display the second execution screen in the third portion r3 of the flexible display 140. In the state 803, the electronic device 100 may display, in the first portion r1 and the second portion r2, the first execution screen reduced according to a size of a combination of the first portion r1 and the second portion r2.

In the state 803 of FIG. 8B, a boundary line between the first execution screen and the second execution screen may be positioned on a foldable portion of the flexible display 140 associated with the second folding axis f2. Since the boundary line is positioned on the foldable portion, a crease formed on the foldable portion is not positioned in the inside of the first execution screen and the second execution screen. For example, distortion of content of the first execution screen and/or the second execution screen due to the crease may be prevented/reduced.

Referring to FIG. 8C, in the state 804 in which the input for dragging the icon 712 along one path among the paths 812 and 813 is being received, the electronic device 100 may display a visual object 841 for guiding a position and/or a size of the second execution screen corresponding to the icon 712. The visual object 841 may have a shape and/or a position occupying the first portion r1 among three portions of the flexible display 140 divided by foldable portions.

In the example state 804 of FIG. 8C, when an input for dragging the icon 712 ceases at a point p2 in the second portion r2 and/or a point p1 in the first portion r1, the electronic device 100 may switch to the state 805. For example, based on an input for moving the icon 712 to one portion among the second portion r2 and the third portion r3, the electronic device 100 may switch to the state 805 for displaying, in the third portion r3, the second execution screen associated with the icon 712. For example, the electronic device 100 may display the second execution screen to a right side of the first execution screen such that the second execution screen to be further displayed by the input is displayed at a position adjacent to a right hand of a user (e.g., a right periphery 140-r of the flexible display 140).

In the state 805 of FIG. 8C, the boundary line between the first execution screen and the second execution screen may be positioned on the foldable portion of the flexible display 140 positioned on a first hinge assembly 150. Since the boundary line is positioned on the foldable portion, contents of the first execution screen and the second execution screen may be spaced apart from the crease formed on the foldable portion. For example, distortion of the contents due to the crease may be prevented/reduced.

As described above, in response to an input for further displaying the second execution screen together with the first execution screen being displayed on the flexible display 140, the electronic device 100 may determine a ratio of sizes of the first execution screen and/or the second execution screen using a property (or a category) of the first execution screen and/or the second execution screen. As described above with reference to FIG. 7A to FIG. 7D, when further displaying the second execution screen having a first property (or a first category) associated with a software application such as a video playback application and/or an execution screen provided from the video playback application, the electronic device 100 may display the second execution screen in a size greater than a size of the first execution screen. As described above with reference to FIG. 8A to FIG. 8C, when further displaying the second execution screen having a second property (or a second category) associated with a software application such as a messenger application and/or an execution screen provided from the messenger application, the electronic device 100 may display the second execution screen in a size smaller than a size of the first execution screen.

For example, a ratio of sizes of execution screens being displayed on the flexible display 140 may be associated with properties (or categories) of the execution screens. The disclosure is not limited thereto, and a ratio of sizes of the execution screens may be dependent on a setting value of a user (e.g., a setting value indicating whether an execution screen of a software application launched (or executed) last is to be displayed relatively large).

In an embodiment, positions and/or an order of the icons 711, 712, and 713 in the visual object 710 may be associated with properties and/or categories of execution screens respectively corresponding to the icons 711, 712, and 713. For example, in the visual object 710, icons included in the first property (or the first category) may be displayed adjacent to each other, and icons included in the second property (or the second category) may be displayed adjacent to each other.

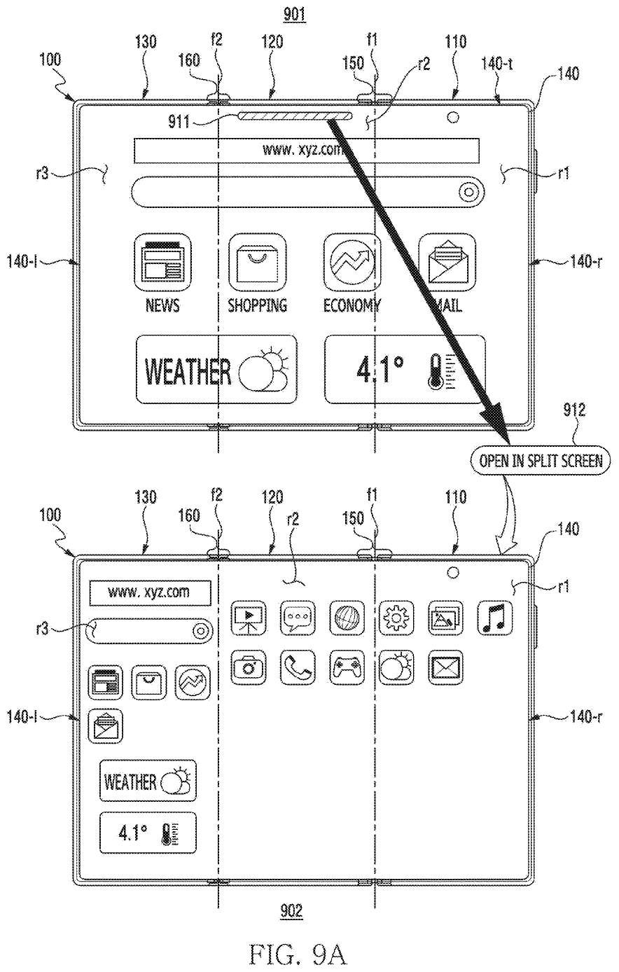

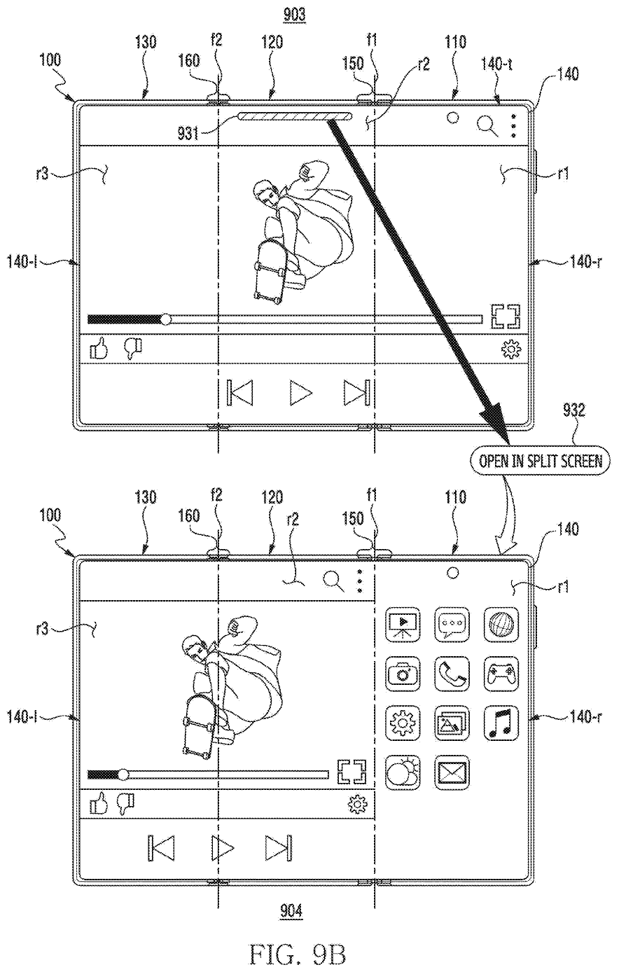

Hereinafter, various example states of the electronic device 100 receiving an input for starting a multi-window are described in greater detail with reference to FIG. 9A and/or FIG. 9B.

FIG. 9A and FIG. 9B are diagrams illustrating example states 901, 902, 903, and 904 of an electronic device 100 associated with an input for additionally displaying an execution screen according to various example embodiments. The electronic device 100 of FIG. 4A, FIG. 4B, and/or FIG. 5, and/or the processor 510 of FIG. 5 may perform an operation of the electronic device 100 described with reference to FIG. 9A and/or FIG. 9B. The operation of the electronic device 100 described with reference to FIG. 9A and/or FIG. 9B may be associated with at least one of the operations of FIG. 6.

Referring to FIG. 9A, the example state 901 of the electronic device 100 displaying a first execution screen (e.g., an execution screen provided from a web browser) on a flexible display 140 is illustrated. In the state 901, the electronic device 100 may display, on the flexible display 140, the first execution screen having a size of an entire displaying region of the flexible display 140. In the state 901 included in an unfolded state, the electronic device 100 may display the first execution screen using the entire displaying region of the flexible display 140. In the example state 901 of FIG. 9A, the electronic device 100 may display a handle 911 for adjusting a position, a shape, and/or a size of the first execution screen. The handle 911 may be referred to as a title bar and/or an indicator. Although the handle 911 having a position adjacent to one periphery (e.g., an upper periphery 140-t) of the flexible display 140 is illustrated, the disclosure is not limited thereto.

In the state 901 of FIG. 9A, using the handle 911, the electronic device 100 may provide an option associated with a multi-window. For example, in response to an input that indicates selecting the handle 911 (e.g., a tap gesture on the handle 911), the electronic device 100 may display a menu 912. The menu 912 may be displayed overlappingly on the handle 911 or may be displayed instead of the handle 911. The menu 912 may include preset text indicating a start of the multi-window, such as “open in split screen”. The disclosure is not limited thereto, and the menu 912 may include an icon, an image, and/or a video (e.g., an animation) representing the multi-window.

While displaying the menu 912, in response to an input that indicates selecting the menu 912 (e.g., a tap gesture on the menu 912), the electronic device 100 may switch to the state 902 of FIG. 9A. While displaying the menu 912, in response to another input different from the input (e.g., a touch gesture on a remaining portion different from a portion of the flexible display 140 on which the menu 912 is displayed), the electronic device 100 may cease displaying the menu 912. When ceasing displaying the menu 912, the electronic device 100 may resume displaying the handle 911.

Referring to FIG. 9A, in the state 902, the electronic device 100 may display, in one portion (e.g., a third portion r3) among portions of the flexible display 140, the first execution screen reduced according to a size of the single portion. In the state 902, the electronic device 100 may display, in remaining two portions (e.g., a combination of a first portion r1 and a second portion r2) among the portions of the flexible display 140, a list of executable software applications. In the example state 902 of FIG. 9A, a list including icons representing the software applications is illustrated, but the disclosure is not limited thereto. Through the list, an input for selecting another execution screen to be displayed together with the first execution screen may be received. For example, in response to a tap gesture for one of the icons included in the list, the electronic device 100 may display, in the first portion r1 and the second portion r2, a second execution screen associated with the icon corresponding to the tap gesture. Based on displaying the second execution screen, displaying of the list in the first portion r1 and the second portion r2 may be ceased.

For example, according to an input received in the state 902 of FIG. 9A, the electronic device 100 may switch to another state (e.g., the state 705 of FIG. 7C and/or FIG. 7D) in which a ratio of sizes of the first execution screen and the second execution screen corresponds to 1:2. The ratio of the sizes may be associated with a property and/or a category of the first execution screen. For example, in the state 901 displaying the first execution screen of a second property (or a second category), the electronic device 100 may display, in the third portion r3, the first execution screen reduced according to a size of the third portion r3 and may display a list in a remaining portion, in response to an input for displaying the list (e.g., an input that indicates selecting the menu 912).

Referring to FIG. 9B, the example state 903 of the electronic device 100 displaying the first execution screen of a first property (e.g., an execution screen provided from a video playback application) on the flexible display 140 is illustrated. In the state 903, the electronic device 100 may display a handle 931 for control of the first execution screen. For example, similarly to the handle 911 of FIG. 9A, the electronic device 100 may display the handle 931 at a position adjacent to the upper periphery 140-t. In response to an input that indicates selecting the handle 931, the electronic device 100 may display a menu 932 including an option associated with a multi-window, similarly to the menu 912 of FIG. 9A. In response to an input that indicates selecting the menu 932, the electronic device 100 may switch from the state 903 to the state 904.

Referring to the example state 904 of FIG. 9B, the electronic device 100 may display, in a combination of two portions (e.g., the second portion r2 and the third portion r3) among portions of the flexible display 140, the first execution screen reduced according to a size of the combination. Together with the first execution screen displayed in the second portion r2 and the third portion r3, the electronic device 100 may display a list of executable software applications. The list may be displayed in the first portion r1 of the flexible display 140. Similarly to the list displayed in the state 902 of FIG. 9A, the electronic device 100 may visualize the list using icons representing the software applications.

In the state 904 of FIG. 9B, the electronic device 100 may receive, through the list, an input to select the second execution screen to be displayed together with the first execution screen. In response to the input, the electronic device 100 may maintain displaying the first execution screen in the second portion r2 and the third portion r3 and may display the second execution screen in the first portion r1. For example, according to the input received in the state 904 of FIG. 9B, the electronic device 100 may switch to another state (e.g., the state 805 of FIG. 8C) in which a ratio of sizes of the first execution screen and the second execution screen corresponds to 2:1.

As described above, according to an embodiment, when receiving an input for displaying the second execution screen while displaying the first execution screen of the second category (or the second property), the electronic device 100 may display the second execution screen in the first portion r1 of a displaying region positioned on a first housing part 110 and a second portion r2 of a displaying region positioned on a second housing part 120 and may display the first execution screen in the third portion r3 of a displaying region defined by a foldable portion of a displaying region corresponding to a second hinge assembly 160 and positioned on a third housing part 130. According to an embodiment, when receiving an input for displaying the second execution screen while displaying the first execution screen of the first category (or the first property), the electronic device 100 may display the first execution screen in the second portion r2 and the third portion r3 defined by a foldable portion of a displaying region corresponding to a first hinge assembly 150 and may display the second execution screen in the first portion r1.

A category of the first execution screen including the first category and the second category may be set by a resource of a software application executed to provide the first execution screen. For example, in an extended marked-up language (XML) file having a name of “manifest.xml”, a tag (or a flag) indicating the category may be stored. The electronic device 100 may check or identify a category (or a property) of the software application and/or the first execution screen using the tag (or the flag). The disclosure is not limited thereto, and the electronic device 100 may check or identify the category (or the property) of the first execution screen being displayed on the flexible display 140 using a list (e.g., a white-list) including package names of software applications of the first category (or the first property).

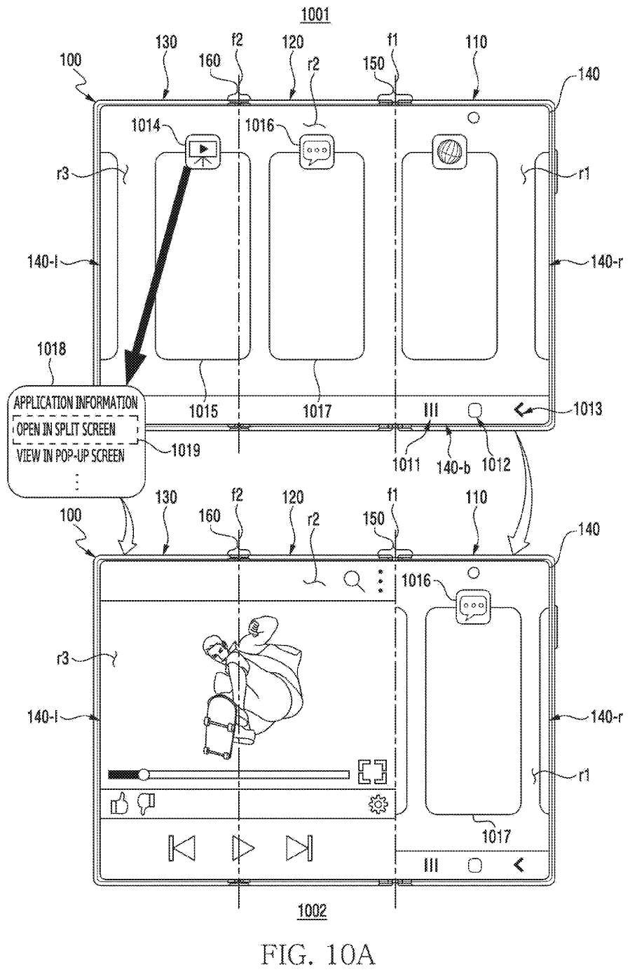

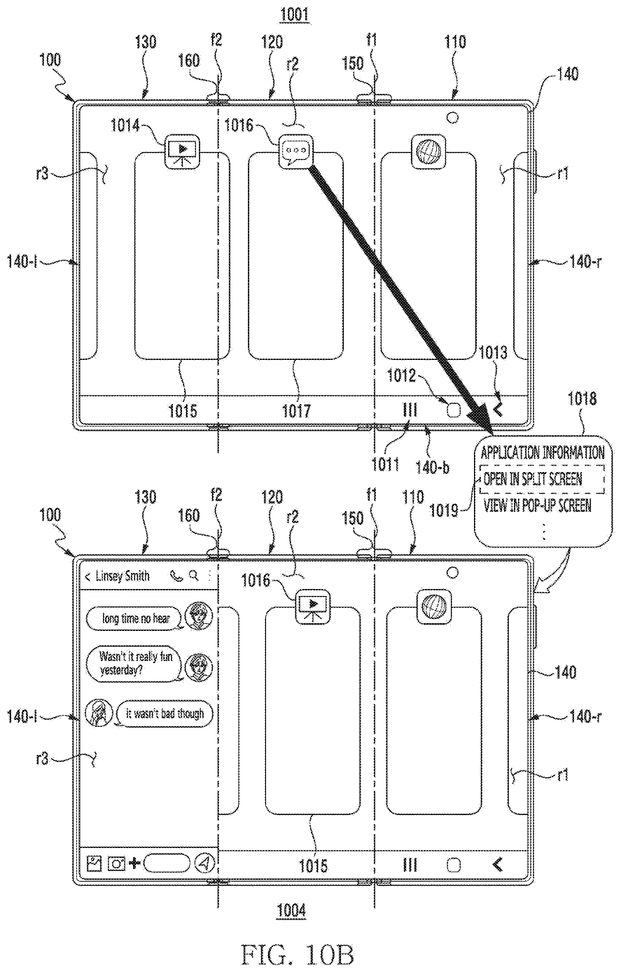

Hereinafter, various example states of the electronic device 100 receiving an input for further displaying the second execution screen together with the first execution screen being displayed on the flexible display 140 are illustrated and described in greater detail below with reference to FIG. 10A and/or FIG. 10B.

FIG. 10A and FIG. 10B are diagrams illustrating example states 1001, 1002, and 1004 of an electronic device 100 associated with an input for additionally displaying an execution screen according to various example embodiments. The electronic device 100 of FIG. 4A, FIG. 4B, and/or FIG. 5, and/or the processor 510 of FIG. 5 may perform an operation of the electronic device 100 described with reference to FIG. 10A and/or FIG. 10B. The operation of the electronic device 100 described with reference to FIG. 10A and/or FIG. 10B may be associated with at least one of the operations of FIG. 6.

Referring to FIG. 10A, the example state 1001 of the electronic device 100 displaying a screen (e.g., a recents screen, an overview screen, a recents task list, and/or a recents app screen) for switching a software application and/or an execution screens is illustrated. A screen displayed through an entire displaying region of a flexible display 140 in the state 1001 may be referred to as a recents screen. A screen displayed in the state 1001 may be mapped to a preset button (e.g., a recents button 1011) of a navigation bar displayed along a lower periphery 140-b of the flexible display 140. For example, in response to an input that indicates selecting the preset button, the electronic device 100 may switch to the state 1001 of FIG. 10A. The navigation bar may include the recents button 1011, a home button 1012, and a back button 1013. The home button 1012 may be mapped to a home screen (or a launcher screen). In response to an input that indicates selecting the back button 1013, the electronic device 100 may be configured to re-display execution screens that were sequentially displayed on the flexible display 140.

In the example state 1001 of FIG. 10A, the electronic device 100 may display each of images representing execution screens that were displayed on the flexible display 140 (or a cover display), together with an icon of a software application corresponding to the execution screen. For example, the electronic device 100 may display an image (e.g., a screen-shot and/or a snapshot) 1015 indicating an execution screen that was displayed by executing a video playback application and an icon 1014 representing the video playback application. For example, the electronic device 100 may display an image 1017 representing an execution screen that was displayed by executing a messenger application and an icon 1016 representing the messenger application. A first combination of the image 1015 and the icon 1014 and a second combination of the image 1017 and the icon 1017 may be scrolled along a horizontal axis of the flexible display 140 by a user input such as a swipe gesture.

In the state 1001 of FIG. 10A, the electronic device 100 may display a menu 1018 in response to an input that indicates selecting the icon 1014. The menu 1018 may be displayed overlappingly on the icon 1014. The menu 1018 may include an option for displaying information on a video application (e.g., an option including text such as “application information”), an option for starting a multi-window based on PBP (e.g., an option including text such as “open in split screen”), and/or an option for starting a multi-window based on PIP (e.g., an option including text such as “view in pop-up screen”).

Referring to FIG. 10A, in the menu 1018, a visual object 1019 indicating the option for starting the multi-window based on the PBP may be displayed. In response to an input that indicates selecting the visual object 1019, the electronic device 100 may switch from the state 1001 to the state 1002. In the state 1002, the electronic device 100 may display, in a combination of two portions (e.g., a second portion r2 and a third portion r3) among portions of the flexible display 140, a first execution screen based on a size of the combination. The first execution screen may correspond to a video playback application corresponding to the icon 1014. The first execution screen of a first category (or a first property) may occupy two portions (e.g., the second portion r2 and the third portion r3) adjacent to a left periphery 140-l of the flexible display 140.

Referring to the state 1002 of FIG. 10A, similarly to the state 904 of FIG. 9B, the electronic device 100 may display, in a first portion r1, a screen for determining a software application to be displayed through the first portion r1. The screen displayed in the first portion r1 may display the recents screen that was displayed in the state 1001. In the state 1002 displaying the recents screen reduced according to a size of the first portion r1, the electronic device 100 may receive, through the recents screen, an input to select a second execution screen to be displayed together with the first execution screen. In response to the input, the electronic device 100 may maintain displaying the first execution screen in the second portion r2 and the third portion r3 and may display the second execution screen in the first portion r1. For example, in response to the input received in the state 1002 of FIG. 10A, the electronic device 100 may switch to another state (e.g., the state 805 of FIG. 8C) in which a ratio of sizes of the first execution screen and the second execution screen corresponds to 2:1.

Referring to FIG. 10B, in the state 1001 displaying the recents screen in the entire displaying region of the flexible display 140, the electronic device 100 may display the menu 1018 in response to an input that indicates selecting the icon 1016. The menu 1018 may be displayed overlappingly on the icon 1016. In the menu 1018, in response to an input that indicates selecting the visual object 1019 corresponding to the option for displaying the multi-window based on the PBP, the electronic device 100 may switch to the state 1004 of FIG. 10B.

Referring to the example state 1004 of FIG. 10B, when the first execution screen (e.g., an execution screen provided from a messenger application) corresponding to the icon 1016 is included in a second category (or a second property) associated with an execution screen of a relatively small size, the electronic device 100 may display the first execution screen in a single portion (e.g., the third portion r3) among portions of the flexible display 140, as in the state 1004.

In the state 1004 of FIG. 10B, similarly to the state 902 of FIG. 9A, the electronic device 100 may display, in a combination of the first portion r1 and the second portion r2, a screen for selecting a software application to be displayed through the combination. For example, the electronic device 100 may display the recents screen reduced according to a size of the first portion r1 and the second portion r2. In the state 1004 of FIG. 10B, the electronic device 100 may receive, through the recents screen, an input to select the second execution screen. For example, in the state 1004, in response to an input that indicates selecting the icon 1014 representing the video playback application, the electronic device 100 may switch to a state displaying the second execution screen provided from the video playback application together with the first execution screen displayed in the third portion r3. For example, the second execution screen may be displayed in a remaining portion (e.g., a combination of the first portion r1 and the second portion r2) of a displaying region different from the third portion r3.

As described above, the electronic device 100 may sequentially receive, through the recent screen, inputs for selecting execution screens to be simultaneously displayed on the flexible display 140. The electronic device 100 may non-uniformly set sizes of the execution screens using properties (or categories) of the execution screens. For example, the sizes of the execution screens may be set such that a boundary line of the execution screens is positioned on a crease of the flexible display 140 formed by a motion of a hinge assembly (e.g., the first hinge assembly 150 and/or the second hinge assembly 160). For example, in order to prevent/suppress reducing visibility of the boundary line or distortion of contents of the execution screens due to the boundary line, the electronic device 100 may determine or change the sizes of the execution screens.

Hereinafter, various example states of the electronic device 100 displaying execution screens having a layout based on the PIP are illustrated and described in greater detail with reference to FIG. 11.

FIG. 11 is a diagram illustrating example states of an electronic device 100 associated with an input for foldable portions fp1 and fp2 of a flexible display 140 according to various example embodiments. The electronic device 100 of FIG. 4A, FIG. 4B, and/or FIG. 5, and/or the processor 510 of FIG. 5 may perform an operation of the electronic device 100 described with reference to FIG. 11.

Referring to FIG. 11, a state 1101 of the electronic device 100 displaying a plurality of execution screens (e.g., a first execution screen based on execution of a web browser and a second execution screen based on execution of a video playback application) is illustrated. The state 1101 of FIG. 11 may correspond to the state 705 of FIG. 7B and/or FIG. 7C. In the state 1101, the electronic device 100 may display a visual object 710. As described above with reference to FIG. 7A, in response to a preset input for displaying the visual object 710, the electronic device 100 may display the visual object 710. The visual object 710 may include icons 711, 712, and 713 respectively representing software applications.

Referring to FIG. 11, the electronic device 100 may receive, through the visual object 710, an input for further adding an execution screen displayed on the flexible display 140. In an example state 1001 displaying the first execution screen in a third portion r3 and displaying the second execution screen in a combination of a first portion r1 and a second portion r2, the electronic device 100 may receive an input for further displaying a third execution screen corresponding to the icon 712. Referring to FIG. 11, as an example of the input, example paths 1111 and 1121 of a gesture for dragging the icon 712 are illustrated. The electronic device 100 receiving an input for dragging the icon 712 along the path 1111 may switch from the state 1101 to a state 1102. The electronic device 100 receiving an input for dragging the icon 712 along the path 1112 may switch from the state 1101 to a state 1103.

For example, the electronic device 100 receiving the input for moving the icon 712 to the first foldable portion fp1 formed on a first hinge assembly 150 along the path 1111 may switch to the state 1102. In the state 1102, the electronic device 100 may display the third execution screen 1121 at least partially overlapping the first foldable portion fp1 and associated with the icon 712. While receiving the input, the electronic device 100 may display a visual affordance for guiding a position, a shape, and/or a size of the third execution screen 1121, such as the visual object 721 of FIG. 7B and the visual object 741 of FIG. 7C and/or FIG. 7D.

For example, the electronic device 100 receiving the input for moving the icon 712 to the second foldable portion fp2 formed on a second hinge assembly 160 along the path 1112 may switch to the state 1103. In the state 1103, the electronic device 100 may display the third execution screen 1121 at least partially overlapping the second foldable portion fp2 and associated with the icon 712.

Although an operation of the electronic device 100 receiving the input for moving the icon 712 to the foldable portions fp1 and fp2 has been described, the disclosure is not limited thereto. In the state 1101 of FIG. 11, the electronic device 100 detecting an input for moving the icon 712 to another portion of the flexible display 140 different from the foldable portions fp1 and fp2 may display three execution screens having a layout based on PBP as described above with reference to FIG. 7E.

In an embodiment, when switching to the state 1103 further displaying the third execution screen while playing a video through the second execution screen associated with the video playback application, the electronic device 100 may at least temporarily stop the video played through the second execution screen. After playing of the video is at least temporarily stopped, the electronic device 100 may play the video again in response to an input for the second execution screen (e.g., a tap gesture on the second execution screen). The input associated with the second execution screen may include an input for focusing on the second execution screen. The disclosure is not limited thereto, and when switching to the state 1103 further displaying the third execution screen while playing audio such as music, the electronic device 100 may at least temporarily stop playing the audio.

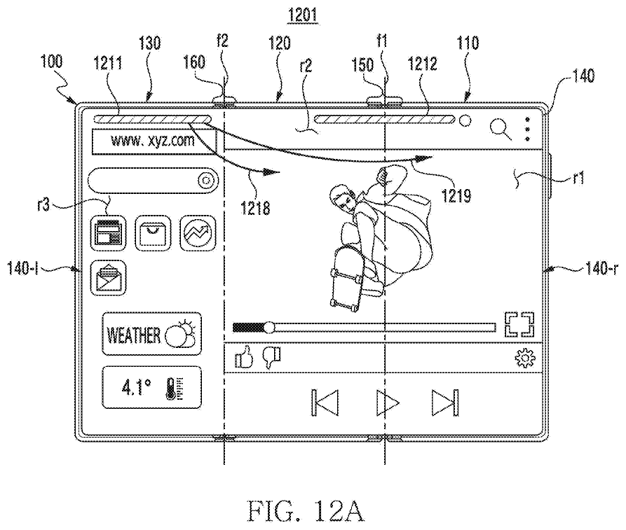

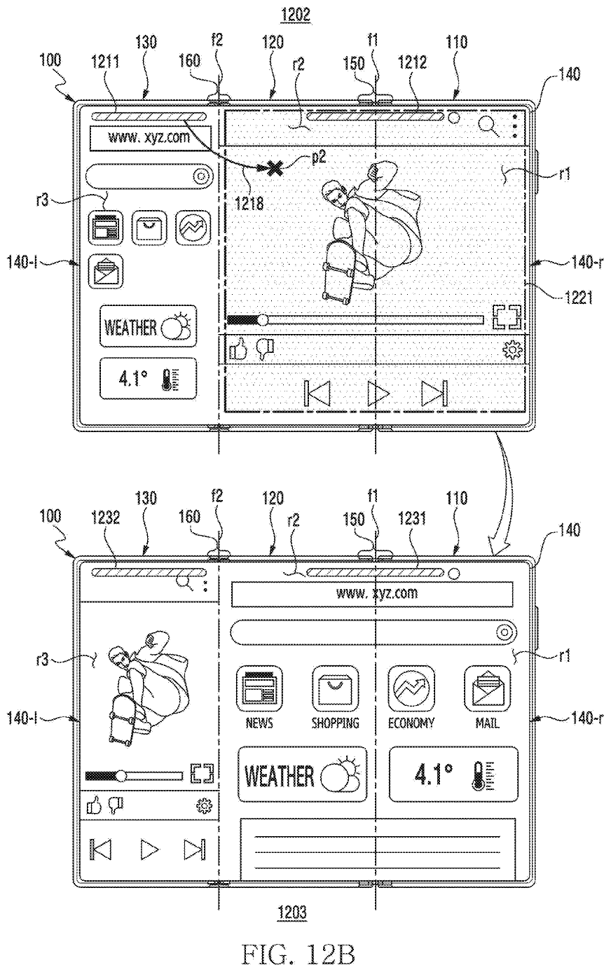

Hereinafter, an example operation of the electronic device 100 receiving an input for changing a layout of execution screens simultaneously displayed on the flexible display 140 is described in greater detail with reference to FIG. 12A, FIG. 12B and FIG. 12C.

FIG. 12A, FIG. 12B, and FIG. 12C are diagrams illustrating example states 1201, 1202, 1203, 1204, and 1205 of an electronic device 100 changing a layout of execution screens according to an input for a visual object such as a handle (e.g., handles 1211, 1212, 1231, 1232, 1251, and 1252) according to various example embodiments. The electronic device 100 of FIG. 4A, FIG. 4B, and/or FIG. 5, and/or the processor 510 of FIG. 5 may perform an operation of the electronic device 100 described with reference to FIG. 12A to FIG. 12C.

Referring to FIG. 12A, the example state 1201 of the electronic device 100 displaying, on a flexible display 140, a first execution screen provided from a web browser and a second execution screen provided from a video playback application is illustrated. The state 1201 of FIG. 12A may correspond to the state 705 of FIG. 7B and/or FIG. 7C. In the state 1201 of FIG. 12A, the electronic device 100 may respectively display the handles 1211 and 1212 on execution screens displayed in different portions of the flexible display 140. Using the handles 1211 and 1212, the electronic device 100 may switch to a mode for changing a layout of the execution screens displayed on the flexible display 140. For example, based on a drag gesture for at least one of the handles 1211 and 1212, the electronic device 100 may change positions and/or sizes of the first execution screen and the second execution screen.

In the example state 1201 of FIG. 12A, the electronic device 100 may receive an input for changing a position and/or a size of the first execution screen using the handle 1211 of the first execution screen positioned in a third portion r3 of the flexible display 140 positioned on a third housing part 130. Referring to FIG. 12A, example paths 1218 and 1219 of drag gestures detected by the electronic device 100 as the input are illustrated. For example, the electronic device 100 detecting a drag gesture performed along the path 1218 may switch from the state 1201 of FIG. 12A to the state 1202 of FIG. 12B. For example, the electronic device 100 detecting a drag gesture performed along the path 1219 may switch from the state 1201 of FIG. 12A to the state 1204 of FIG. 12C.

Referring to FIG. 12B, the example state 1202 of the electronic device 100 receiving an input for moving the handle 1211 to a second portion r2 of the flexible display 140 positioned on a second housing part 120 along the path 1218 is illustrated. In the state 1202, the electronic device 100 may display a visual object 1221 for guiding that the first execution screen corresponding to the handle 1211 by the input is displayed in a first portion r1 and a second portion r2 of the flexible display 140. Similarly to the visual object 721 of FIG. 7B and the visual object 741 of FIG. 7C and/or FIG. 7D, the visual object 1221 may display a visual affordance for guiding a position, a shape, and/or a size of the first execution screen.

In the state 1202 of FIG. 12B, when an input for dragging the handle 1211 ceases on a point p2 in the second portion r2, the electronic device 100 may switch to the state 1203. In the state 1203, the electronic device 100 may display, in a combination of the first portion r1 and the second portion r2 of the flexible display 140, the first execution screen enlarged according to a size of the combination. In the state 1203, the electronic device 100 may display, in the third portion r3 of the flexible display 140, the second execution screen reduced according to a size of the third portion r3. Similarly to the state 1201 of FIG. 12A, the electronic device 100 may display the handle 1231 associated with the enlarged first execution screen and the handle 1232 associated with the reduced second execution screen. For example, in response to the input for moving the handle 1211 of the first execution screen having a relatively small size to the second portion r2, the electronic device 100 may change a position and a size of the first execution screen.

Referring to FIG. 12C, the example state 1204 of the electronic device 100 receiving an input for moving the handle 1211 to the first portion r1 of the flexible display 140 positioned on a first housing part 110 along the path 1219 is illustrated. In the state 1204, a visual object 1241 for guiding that the first execution screen corresponding to the handle 1211 is displayed in the first portion r1 may be displayed. Similarly to the visual object 1221 of FIG. 12B, the visual object 1241 may be displayed to guide a position, a shape, and/or a size of the first execution screen.

In the state 1204 of FIG. 12C, when an input for dragging the handle 1211 ceases on a point p1 in the first portion r1, the electronic device 100 may switch to the state 1205. In the state 1205, the electronic device 100 may display the first execution screen in the first portion r1 of the flexible display 140. In the state 1205, the electronic device 100 may display the second execution screen in a combination of the second portion r2 and the third portion r3 of the flexible display 140. Referring to the state 1201 of FIG. 12A and the state 1205 of FIG. 12C, the electronic device 100 may swap positions in which the first execution screen and the second execution screen are displayed. While switching from the state 1201 of FIG. 12A to the state 1205 of FIG. 12C, a size of the first execution screen and a size of the second execution screen may be maintained. After switching to the state 1205, the electronic device 100 may display overlappingly the handle 1251 corresponding to the first execution screen on the first execution screen, and may display overlappingly the handle 1252 corresponding to the second execution screen on the second execution screen.

Although an operation of the electronic device 100 associated with the handle 1311 of the first execution screen having a relatively small size has been described, the disclosure is not limited thereto. For example, based on an input for the handle 1312 of the second execution screen having a relatively large size, the electronic device 100 may change a layout of execution screens displayed on the flexible display 140.

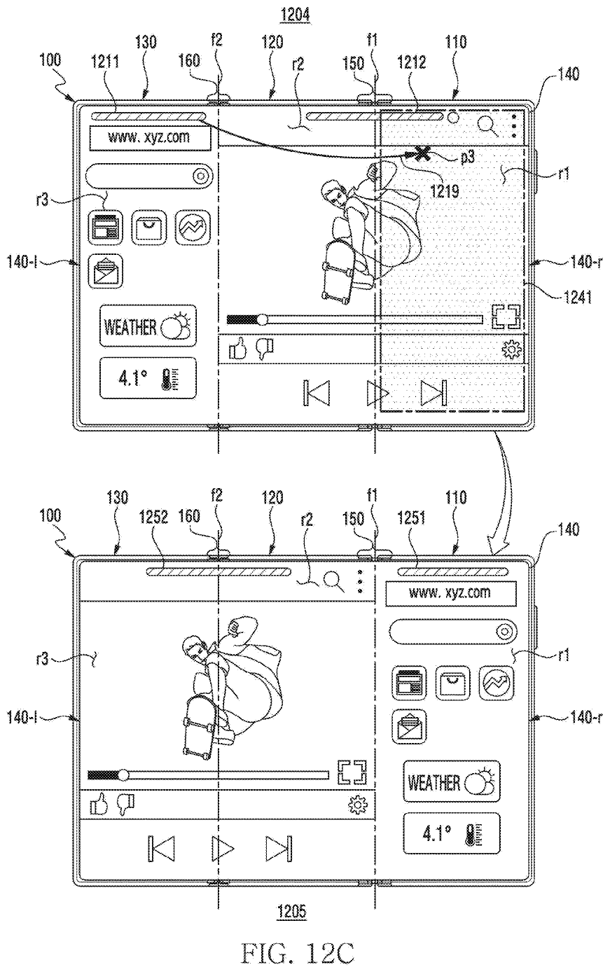

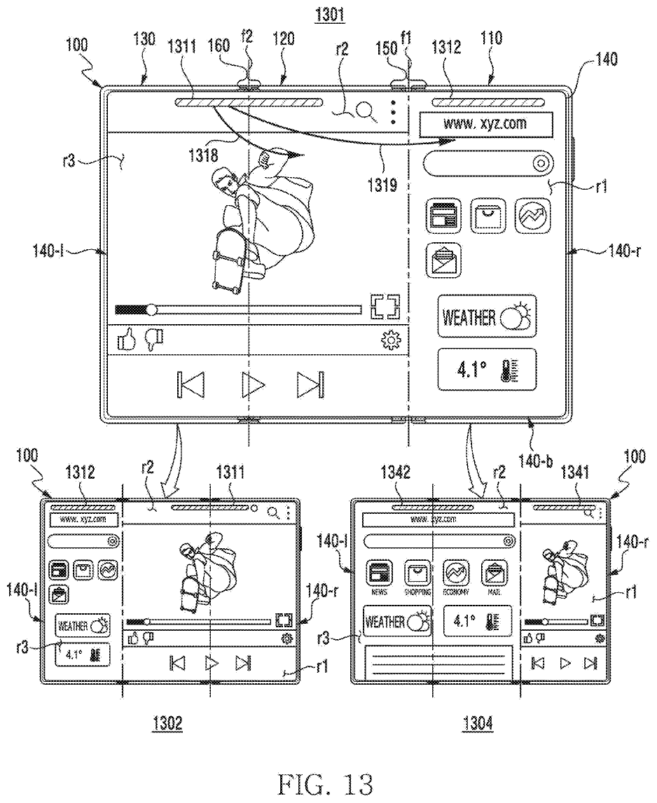

FIG. 13 is a diagram illustrating example states 1301, 1302, and 1304 of an electronic device changing a layout of execution screens according to an input for a visual object such as a handle (e.g., handles 1311, 1312, 1341, and 1342) according to various example embodiments. The electronic device 100 of FIG. 4A, FIG. 4B, and/or FIG. 5, and/or the processor 510 of FIG. 5 may perform an operation of the electronic device 100 described with reference to FIG. 13.

Referring to FIG. 13, the example state 1301 of the electronic device 100 displaying, on a flexible display 140, a first execution screen provided from a video playback application and a second execution screen provided from a web browser is illustrated. The electronic device 100 may display overlappingly the handle 1311 configured to receive an input for controlling the first execution screen on the first execution screen. The electronic device 100 may display overlappingly the handle 1312 configured to receive an input for controlling the second execution screen on the second execution screen. In response to a drag gesture for at least one of the handles 1311 and 1312, the electronic device 100 may change positions and/or sizes of the first execution screen and the second execution screen.

In the example state 1301 of FIG. 13, the electronic device 100 may receive an input for changing a position and/or a size of the first execution screen using the handle 1311 of the first execution screen occupying a second portion r2 and a third portion r3 of the flexible display 140. The input may include drag gestures for moving the handle 1311 along paths 1318 and 1319. The electronic device 100 detecting a drag gesture performed along the path 1318 may switch from the state 1301 to the state 1302 of FIG. 13. The electronic device 100 detecting a drag gesture performed along the path 1319 may switch from the state 1301 to the state 1304 of FIG. 13.

Referring to FIG. 13, in the state 1302, the electronic device 100 may change a position in which the first execution screen is displayed from a combination of the second portion r2 and the third portion r3 to a combination of a first portion r1 and the second portion r2. In the state 1302, the electronic device 100 may display, in the third portion r3, the second execution screen displayed in the first portion r1 in the state 1301 before the state 1302. The electronic device 100 receiving an input for moving the first execution screen to the second portion r2 along a path 1308 may swap positions of the first execution screen and the second execution screen while maintaining sizes of the first execution screen and the second execution screen.

Referring to FIG. 13, in the state 1304, the electronic device 100 may display the first execution screen according to a size reduced according to a size of the first portion r1. In the state 1304, the electronic device 100 may display, in a combination of the second portion r2 and the third portion r3, the second execution screen enlarged according to a size of the combination. The electronic device 100 may display overlappingly the handle 1341 on the first execution screen and may display overlappingly the handle 1342 on the second execution screen.

Referring to FIG. 12A to FIG. 12C and FIG. 13, the electronic device 100 receiving an input for moving a handle (e.g., the handle 1211 of FIG. 12A and/or the handle 1311 of FIG. 13) to the second portion r2 may determine whether to change a size of an execution screen according to a size of the execution screen corresponding to the handle. As described above with reference to FIG. 12A, based on an input for moving a handle (e.g., the handle 1211 of FIG. 12A) of an execution screen having a relatively small size (e.g., the first execution screen having the size of the first portion r3) to the second portion r2, the electronic device 100 may change a position of the execution screen and may enlarge the size of the execution screen. As described above with reference to FIG. 13, based on an input for moving a handle (e.g., the handle 1311 of FIG. 13) of an execution screen having a relatively large size (e.g., the first execution screen having the size of the combination of the second portion r2 and the third portion r3) to the second portion r2, the electronic device 100 may change a position of the execution screen and may maintain the size of the execution screen.

Although an operation of the electronic device 100 for an input for moving a handle (e.g., the handle 1211 of FIG. 12A and/or the handle 1311 of FIG. 13) of an execution screen positioned on a left side among two execution screens has been described, the disclosure is not limited thereto. For example, the electronic device 100 receiving an input for moving a handle (e.g., the handle 1212 of FIG. 12A and/or the handle 1312 of FIG. 13) of an execution screen positioned on a right side among two execution screens may change a layout of the execution screens similarly to the operation described above with reference to FIG. 12A to FIG. 12C and/or FIG. 13.

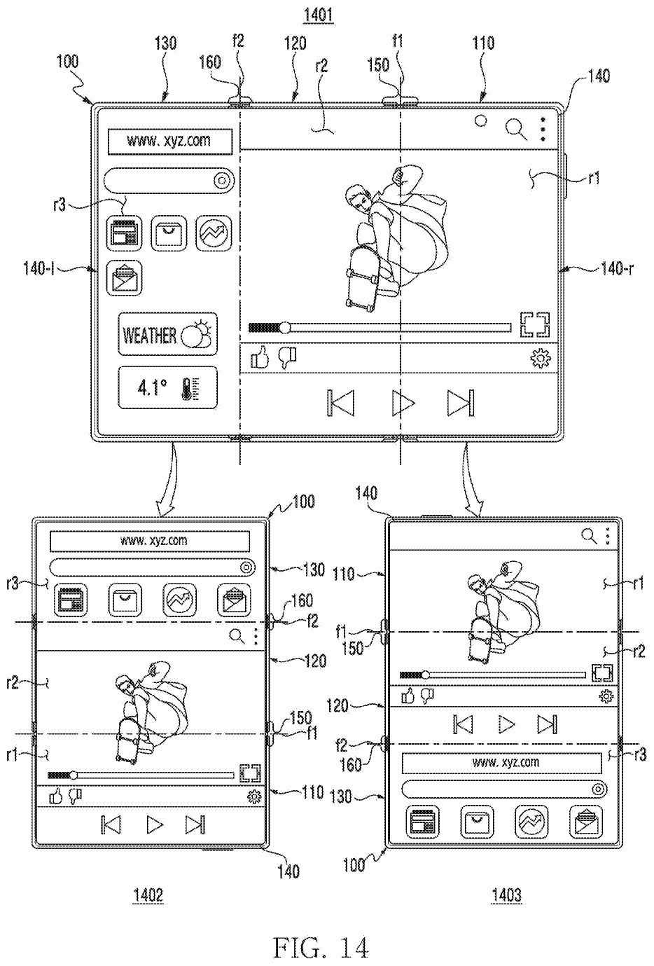

Hereinafter, an example operation of the electronic device 100 for changing a layout of execution screens displayed on the flexible display 140 according to rotation of the electronic device 100 is described in greater detail with reference to FIG. 14.

FIG. 14 is a diagram illustrating example states 1401, 1402, and 1403 of an electronic device 100 changing a layout of execution screens according to rotation of the electronic device 100 according to various example embodiments. The electronic device 100 of FIG. 4A, FIG. 4B, and/or FIG. 5, and/or the processor 510 of FIG. 5 may perform an operation of the electronic device 100 described with reference to FIG. 14.

Referring to FIG. 14, the example state 1401 of the electronic device 100 displaying, on a flexible display 140, a first execution screen corresponding to a web browser and a second execution screen corresponding to a video playback application is illustrated. The first execution screen may be displayed in a third portion r3 on a third housing part 130, and the second execution screen may be displayed in a first portion r1 on a first housing part 110 and a second portion r2 on a second housing part 120.

According to an embodiment, the electronic device 100 may detect or measure a direction and/or an orientation of the electronic device 100 using a sensor (e.g., the sensor 530 of FIG. 5). The direction and/or the orientation of the electronic device 100 may be determined according to a direction of gravitational acceleration applied to the electronic device 100. According to the direction and/or the orientation of the electronic device 100, a mode for displaying an execution screen on the flexible display 140 may be changed.

The mode may include preset modes referred to as a portrait mode and a landscape mode. In an embodiment including the flexible display 140 having a width longer than a height, the landscape mode may include a state in which gravitational acceleration applied to the electronic device 100 is perpendicular to the width and may be set to display character strings along a direction of the width. In an embodiment including the flexible display 140 having the width longer than the height, the portrait mode may include a state in which gravitational acceleration applied to the electronic device 100 is parallel to the width and may be set to display character strings along a direction of the height. For example, in the state 1401 of FIG. 14, the electronic device 100 may display execution screens based on the landscape mode.

Referring to FIG. 14, as the electronic device 100 is physically rotated, a mode of the electronic device 100 may be switched from the landscape mode (e.g., the state 1401) to the portrait mode (e.g., the states 1402 and 1403). The electronic device 100 may determine a mode corresponding to the electronic device 100 from among the landscape mode and the portrait mode using a sensor (e.g., the IMU 532 and/or the gravity sensor of FIG. 5). In the state 1401 of FIG. 14, when the electronic device 100 is rotated by 90° clockwise by a user, the electronic device 100 may switch to the state 1402 in the portrait mode. In the state 1401 of FIG. 14, when the electronic device 100 is rotated by 90° counterclockwise by a user, the electronic device 100 may switch to the state 1403 in the portrait mode.

When switching from the landscape mode to the portrait mode, the electronic device 100 may determine positions and/or sizes of execution screens according to positions of foldable portions of the flexible display 140. In the example state 1402 of FIG. 14, the electronic device 100 may display the first execution screen in the portrait mode in the third portion r3 of the flexible display 140 positioned on the third housing part 130. In the state 1402, the electronic device 100 may display the second execution screen in the portrait mode in a combination of the first portion r1 of the flexible display 140 positioned on the first housing part 110 and the second portion r2 of the flexible display 140 positioned on the second housing part 120. When switching from the state 1401 to the state 1402 of FIG. 14, mapping of the housing parts and the execution screens may be maintained.

In the example state 1403 of FIG. 14, the electronic device 100 may display the second execution screen in the portrait mode in a combination of the first portion r1 and the second portion r2 and may display the first execution screen in the portrait mode in the third portion r3. When switching from the state 1401 to the state 1403 of FIG. 14, the electronic device 100 may change directions of contents of execution screens and/or may rotate the contents, while maintaining mapping of the housing parts and the execution screens.

Referring to the states 1402 and 1403 of FIG. 14, a boundary line of the execution screens may be formed on one of the foldable portions. Since a crease included in the foldable portion is positioned on the boundary line, distortion of contents of the execution screens due to the crease may be reduced or prevented.

In an embodiment, when switching from the landscape mode to the portrait mode, the electronic device 100 may change sizes of execution screens displayed on the flexible display 140 to equivalent sizes. For example, after switching to the portrait mode, the electronic device 100 may respectively display execution screens equally occupying the flexible display 140.

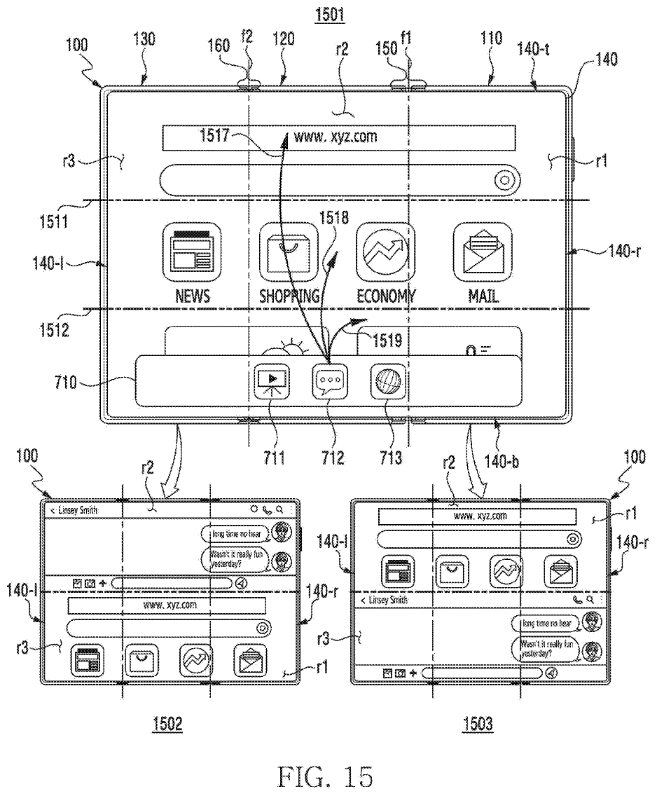

FIG. 15 is a diagram illustrating example states 1501, 1502, and 1503 of an electronic device 100 changing a layout of execution screens according to an input for a visual object such as an icon (e.g., icons 711, 712, and 713) according to various example embodiments. The electronic device 100 of FIG. 4A, FIG. 4B, and/or FIG. 5, and/or the processor 510 of FIG. 5 may perform an operation of the electronic device 100 described with reference to FIG. 15.

Referring to FIG. 15, the state 1501 of the electronic device 100 displaying, in an entire displaying region of a flexible display 140, a first execution screen based on execution of a web browser is illustrated. The state 1501 of FIG. 15 may be associated with the state 701 of FIG. 7A. Referring to FIG. 15, the electronic device 100 may receive, through a visual object 710, an input for selecting an execution screen to be additionally displayed on the flexible display 140. For example, the electronic device 100 may receive, based on the icon 712, an input for further displaying a second execution screen associated with the icon 712. Referring to FIG. 15, according to an embodiment, the electronic device 100 may receive an input for sequentially disposing execution screens along a vertical direction on the flexible display 140.

For example, the electronic device 100 detecting a drag gesture moving the icon 712 may determine a layout of execution screens using a coordinate of an end point (e.g., a y-coordinate of the end point) of the drag gesture. For example, when the end point of the drag gesture is included in a portion between a first reference line 1511 in the flexible display 140 and an upper periphery 140-t of the flexible display 140, the electronic device 100 may display, in a half of the flexible display 140 adjacent to the upper periphery 140-t, the second execution screen corresponding to the icon 712, and may display the first execution screen below the second execution screen on the flexible display 140. The first reference line 1511 may be positioned in a portion spaced apart from the upper periphery 140-t by ⅓ of a height of the flexible display 140 along a height direction of the flexible display 140.

For example, in the state 1501 of FIG. 15, the electronic device 100 receiving a drag gesture moving the icon 712 along a path 1517 may switch to the state 1502, since an end point of the drag gesture is positioned between the first reference line 1511 and the upper periphery 140-t of the flexible display 140. In the example state 1502 of FIG. 15, the electronic device 100 may display, in an upper half adjacent to the upper periphery 140-t, the second execution screen corresponding to the icon 712 and may display, in a lower half adjacent to a lower periphery 140-b, the first execution screen. While receiving the drag gesture moving the icon 712 along the path 1517, the electronic device 100 may display a visual affordance for guiding displaying of the second execution screen in the upper half.

For example, when an end point of a drag gesture is included in a portion between a second reference line 1512 in the flexible display 140 and the lower periphery 140-b, the electronic device 100 may display, in a half of the flexible display 140 adjacent to the lower periphery 140-b, the second execution screen corresponding to the icon 712 and may display the first execution screen above the second execution screen on the flexible display 140. The second reference line 1512 may be positioned in a portion spaced apart from the upper periphery 140-t by ⅔ of the height of the flexible display 140 along the height direction. The first reference line 1511 and the second reference line 1512 are virtual lines illustrated for convenience of description, and the electronic device 100 may determine a layout of execution screens by comparing a y-coordinate of the first reference line 1511 and/or a y-coordinate of the second reference line 1512 with the y-coordinate of the end point of the drag gesture.

For example, in the state 1501 of FIG. 15, the electronic device 100 receiving a drag gesture moving the icon 712 along a path 1519 may switch to the state 1503 since an end point of the drag gesture is positioned between the second reference line 1512 and the lower periphery 140-b of the flexible display 140. In the example state 1503 of FIG. 15, the electronic device 100 may display the second execution screen corresponding to the icon 712 in a lower half adjacent to the lower periphery 140-b and may display the first execution screen in an upper half adjacent to the upper periphery 140-t. While receiving the drag gesture moving the icon 712 along the path 1519, the electronic device 100 may display a visual affordance indicating displaying of the second execution screen in the lower half.

For example, when an end point of a drag gesture is included in a portion between the first reference line 1511 and the second reference line 1512 in the flexible display 140, the electronic device 100 may determine a layout of execution screens similarly to the input associated with the icon 712 described with reference to FIG. 8A to FIG. 8C. For example, the electronic device 100 detecting a drag gesture moving the icon 712 along a path 1518 may determine a layout of execution screens such that the first execution screen and the second execution screen are non-uniformly allocated to a first portion r1, a second portion r2, and a third portion r3, since an end point of the drag gesture is positioned between the first reference line 1511 and the second reference line 1512 in the second portion r2.

For example, when the second execution screen to be displayed by the drag gesture moving the icon 712 along the path 1518 is set to be displayed in a relatively larger size than the first execution screen being displayed when the drag gesture is received, the electronic device 100 may display the second execution screen in a combination of the first portion r1 and the second portion r2 and may display the first execution screen in the third portion r3. While receiving the drag gesture, the electronic device 100 may display overlappingly a visual affordance indicating a position, a shape, and/or a size of the second execution screen on the first execution screen.

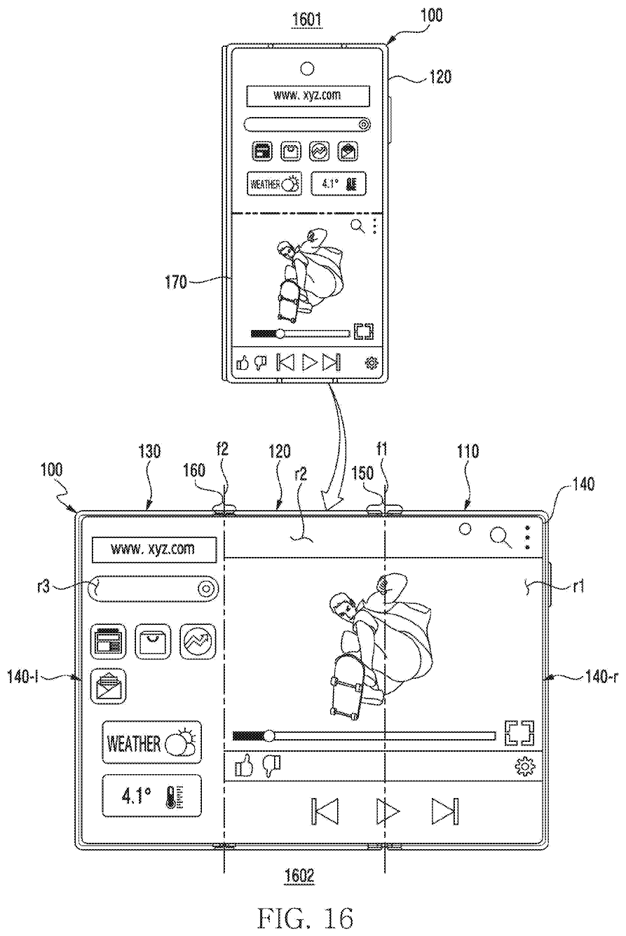

FIG. 16 is a diagram illustrating example states of an electronic device 100 including a cover display 170 and a flexible display 140 according to various example embodiments. The electronic device 100 of FIG. 4A, FIG. 4B, and/or FIG. 5, and/or the processor 510 of FIG. 5 may perform an operation of the electronic device 100 described with reference to FIG. 16.

Referring to FIG. 16, an example state 1601 of the electronic device 100 included in a folded state is illustrated. In the folded state, the electronic device 100 may display, on the cover display 170, a plurality of execution screens based on a multi-window. For example, the electronic device 100 may display a first execution screen in an upper half of the cover display 170 and may display a second execution screen in a lower half of the cover display 170. Sizes of portions of the cover display 170 occupied by execution screens may be equal to each other.

In an embodiment, the electronic device 100 may detect or determine whether a state and/or a shape of the electronic device 100 is changed, using a sensor (e.g., the sensor 530 of FIG. 5). Referring to FIG. 16, as a user unfolds the electronic device 100 from the folded state including the state 1601, the state of the electronic device 100 may be switched to an unfolded state. Referring to FIG. 16, in a state 1602 in the unfolded state switched from the state 1601, the electronic device 100 may continuously display, on the flexible display 140, execution screens displayed through the cover display 170. The execution screens displayed on the cover display 170 may be redisposed or updated based on a size of the flexible display 140.

In an embodiment, the electronic device 100 may determine sizes of execution screens to be displayed on the flexible display 140 using properties (or categories) of the execution screens. For example, when switching from the state 1601 displaying, on the cover display 170, the first execution screen based on a web browser and the second execution screen based on a video playback application to the state 1602, the electronic device 100 may identify at least one property (or category) of the first execution screen and the second execution screen. Since the second execution screen based on the video playback application has a first property and the first execution screen based on the web browser has a second property, the electronic device 100 may determine that the second execution screen has a greater size than the first execution screen on the flexible display 140.

Referring to FIG. 16, in the state 1602, among portions (e.g., a first portion r1, a second portion r2, and a third portion r3) of the flexible display 140 divided by foldable portions of the flexible display 140 positioned on hinge assemblies (e.g., a first hinge assembly 150 and/or a second hinge assembly 160), the electronic device 100 may display the second execution screen through two portions (e.g., the first portion r1 and the second portion r2), and may display the first execution screen through one portion (e.g., the third portion r3). For example, a ratio of sizes of the first execution screen and the second execution screen may be 1:2. A boundary line of the first execution screen and the second execution screen may be positioned on a foldable portion of the flexible display 140 formed by the second hinge assembly 160. For example, since the boundary line is formed along a crease formed on the foldable portion, a user may view contents of the first execution screen and the second execution screen without distortion of the contents due to the crease.

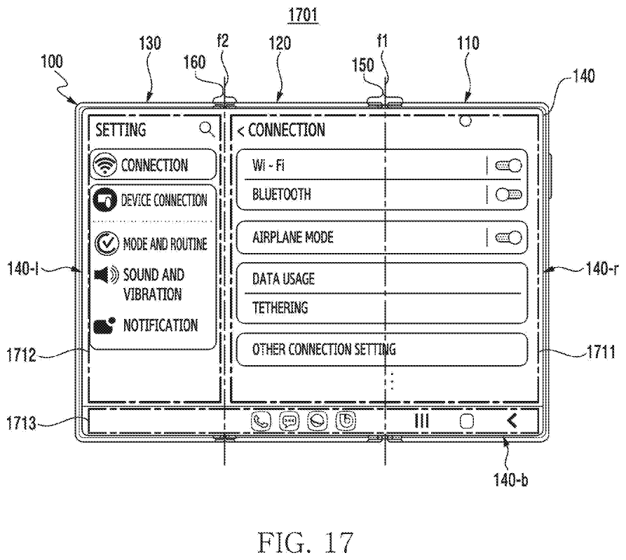

FIG. 17 is a diagram illustrating an example state of an electronic device 100 displaying an execution screen having a layout based on a foldable portion of a flexible display 140 according to various example embodiments. The electronic device 100 of FIG. 4A, FIG. 4B, and/or FIG. 5, and/or the processor 510 of FIG. 5 may perform an operation of the electronic device 100 described with reference to FIG. 17.

Referring to FIG. 17, an example state 1701 of the electronic device 100 displaying an execution screen having a layout based on a shape and/or a size of the flexible display 140 is illustrated. The execution screen displayed in the state 1701 may be provided by a software application executed by the electronic device 100. A mode of the electronic device 100 for displaying the execution screen having the layout based on the size of the flexible display 140 may include a tablet mode and/or a landscape mode.

In the example state 1701 of FIG. 17, the electronic device 100 may display an execution screen including fragment regions 1711 and 1712. Through the first fragment region 1711, the electronic device 100 may display content corresponding to items (e.g., options of a menu) displayed in the second fragment region 1712. The first fragment region 1711 may be referred to as a content region, and the second fragment region 1712 may be referred to as a menu region (or a list region or a navigation region). Together with the fragment regions 1711 and 1712, the electronic device 100 may display a navigation bar 1713. Although the example state 1701 displaying the navigation bar 1713 adjacent to a lower periphery 140-b of the flexible display 140 is illustrated, the disclosure is not limited thereto.

According to an embodiment, when displaying the execution screen including the fragment regions 1711 and 1712, the electronic device 100 may determine or change sizes, positions, and/or shapes of the fragment regions 1711 and 1712 such that a boundary line between the fragment regions 1711 and 1712 is positioned on one portion among foldable portions of the flexible display 140 positioned on folding axes (e.g., a first folding axis f1 and a second folding axis f2).

Referring to the example state 1701 of FIG. 17, the electronic device 100 may display the fragment regions 1711 and 1712 contacted in a foldable portion positioned on the second folding axis f2. For example, the boundary line of the fragment regions 1711 and 1712 may be formed along a crease formed on the flexible display 140 based on the second folding axis f2. Since a boundary line parallel to the crease is positioned on the crease, contents included in each of the fragment regions 1711 and 1712 may not be distorted or bent by the crease.

As described above, according to an embodiment, the electronic device 100 may display one or more execution screens having a layout based on a plurality of creases formed on the flexible display 140. For example, when displaying a plurality of execution screens, the electronic device 100 may determine a layout of the plurality of execution screens such that a boundary line between the execution screens is positioned on one of the plurality of creases. For example, when displaying an execution screen including a plurality of regions (e.g., the fragment regions 1711 and 1712), the electronic device 100 may determine dimensions (e.g., positions, widths, heights, shapes, sizes, and/or aspect ratios) of the plurality of regions such that a boundary line between the plurality of regions is positioned on one of the plurality of creases.

In an embodiment, a method for displaying an execution screen based on a shape of foldable portions (e.g., portions in which a crease is formed) of a flexible display formed by folding axes, on the flexible display positioned on a multi-foldable housing including two or more folding axes may be required. As described above, according to an example embodiment, an electronic device (e.g., the electronic device 100 of FIG. 5) may comprise a housing including a first housing part (e.g., the first housing part 110 of FIG. 4A and/or FIG. 4B), a second housing part rotatably coupled to the first housing part (e.g., the second housing part 120 of FIG. 4A and/or FIG. 4B), and a third housing part rotatably coupled to the second housing part (e.g., the third housing part 130 of FIG. 4A and/or FIG. 4B), a flexible display (e.g., the flexible display 140 of FIG. 4A and/or FIG. 4B) disposed on front sides of the first housing part, the second housing part, and the third housing part, memory (e.g., the memory 520 of FIG. 5), comprising one or more storage mediums, storing instructions, and at least one processor (e.g., the processor 510 of FIG. 5) comprising processing circuitry. The at least one processor may be configured to display a first execution screen on the flexible display. The at least one processor may be configured to, based on receiving the input for dragging an icon (e.g., the icons 711, 712, and 713 of FIG. 7A) to a first portion (e.g., the first portion r1 of FIG. 4A) of the flexible display positioned on the first housing part or a second portion (e.g., the second portion r2 of FIG. 4A) of the flexible display positioned on the second housing part, display the second execution screen in the first portion and the second portion. The at least one processor may be configured to display the first execution screen reduced according to a size of a third portion (e.g., the third portion r3 of FIG. 4A) in the third portion of the flexible display positioned on the third housing part. The at least one processor may be configured to, based on receiving the input for dragging the icon to the third portion of the flexible display, display the first execution screen reduced according to a size of the first portion in the first portion. The at least one processor may be configured to display the second execution screen in the second portion and the third portion. According to an embodiment, the electronic device may display an execution screen based on the shape of the foldable portions of the flexible display formed by the folding axes, on the flexible display positioned on the multi-foldable housing including two or more folding axes.

According to an example embodiment, an electronic device may comprise a housing including a first housing part, a second housing part rotatably coupled to the first housing part, and a third housing part rotatably coupled to the second housing part, a flexible display disposed on a front side of the first housing part, the second housing part, and the third housing part, memory, comprise one or more storage mediums, storing instructions, and at least one processor comprise processing circuitry. The instructions, when executed by the at least one processor individually and/or collectively, may cause the electronic device to display a first execution screen associated with a first application on the flexible display. The instructions, when executed by the at least one processor individually and/or collectively, may cause the electronic device to display at least one icon associated with at least one application in a portion of the flexible display. The instructions, when executed by the at least one processor individually and/or collectively, may cause the electronic device to receive an input to move the at least one icon to a defined portion of the flexible display. The instructions, when executed by the at least one processor individually and/or collectively, may cause the electronic device to, based on receiving the input, display a second execution screen associated with the at least one application in the defined portion of the flexible display, and display the first execution screen associated with the first application by moving the first execution screen to a left side or a right side of the second execution screen.

For example, the instructions, when executed by the at least one processor individually and/or collectively, may cause the electronic device to display the second execution screen, based on receiving the input while a state of the housing is corresponding to an unfolded state.

For example, the electronic device may comprise a first sensor configured to detect a first angle between the first housing part and the second housing part, and a second sensor configured to detect a second angle between the second housing part and the third housing part. The instructions, when executed by the at least one processor individually and/or collectively, may cause the electronic device to, in response to detecting the first angle and the second angle which are included in a preset angle range including 180°, determine that the state of the housing is corresponding to the unfolded state.

For example, the housing may comprise a first hinge assembly (e.g., the first hinge assembly 150 of FIG. 4A and/or FIG. 4B) rotatably coupling the first housing part and the second housing part, and a second hinge assembly (e.g., the second hinge assembly 160 of FIG. 4A and/or FIG. 4B) rotatably coupling the second housing part and the third housing part. The first portion of the flexible display positioned on the first housing part may be distinguished from a remaining portion of the flexible display by a first foldable portion of the flexible display corresponding to the first hinge assembly. The third portion of the flexible display positioned on the third housing part may be distinguished from a remaining portion of the flexible display by a second foldable portion of the flexible display corresponding to the second hinge assembly.

For example, the defined portion may include a boundary that is positioned on the second hinge assembly and is parallel to a direction to which the second hinge assembly is extended. The defined portion may include a boundary that is positioned on the first hinge assembly and is parallel to a direction to which the first hinge assembly is extended.

For example, the instructions, when executed by the at least one processor individually and/or collectively, may cause the electronic device to, based on receiving the input associated with the second execution screen of a software application included in a preset category, display the second execution screen occupying at least two portions among the first portion, the second portion, and the third portion.

For example, the instructions, when executed by the at least one processor individually and/or collectively, may cause the electronic device to, based on receiving another input associated with a third execution screen of a software application of another category different from the preset category, display the second execution screen in one portion among the first portion and the third portion. The instructions, when executed by the at least one processor individually and/or collectively, may cause the electronic device to display the first execution screen in an entire remaining portion different from the portion among the first portion and the third portion where the second execution screen is displayed.

For example, the instructions, when executed by the at least one processor individually and/or collectively, may cause the electronic device to, based on receiving the input in a landscape mode defined by an orientation of the electronic device, display the second execution screen occupying at least two portions among the first portion, the second portion, and the third portion.

For example, the instructions, when executed by the at least one processor individually and/or collectively, may cause the electronic device to, while displaying, together with the first execution screen, the second execution screen occupying at least two portions among the first portion, the second portion, and the third portion, check whether a mode of the electronic device switches from the landscape mode to a portrait mode. The instructions, when executed by the at least one processor individually and/or collectively, may cause the electronic device to, based on switching of the mode of the electronic device to the portrait mode, display the first execution screen and the second execution screen with equivalent sizes.

As described above, in an example embodiment, a method of an electronic device may be provided. The electronic device may comprise a housing including a first housing part, a second housing part rotatably coupled to the first housing part, and a third housing part rotatably coupled to the second housing part, and a flexible display disposed on front sides of the first housing part, the second housing part, and the third housing part. The method may comprise displaying a first execution screen on the flexible display. The method may comprise receiving an input for dragging an icon associated with a second execution screen. The method may comprise, based on receiving the input for dragging the icon to a first portion of the flexible display positioned on the first housing part or a second portion of the flexible display positioned on the second housing part, displaying the second execution screen in the first portion and the second portion. The method may comprise displaying the first execution screen reduced according to a size of a third portion in the third portion of the flexible display positioned on the third housing part. The method may comprise, based on receiving the input for dragging the icon to the third portion of the flexible display, displaying the first execution screen reduced according to a size of the first portion in the first portion. The method may comprise displaying the second execution screen in the second portion and the third portion.

In an example embodiment, a method of an electronic device may be provided. The electronic device may comprise a housing including a first housing part, a second housing part rotatably coupled to the first housing part, and a third housing part rotatably coupled to the second housing part, and a flexible display disposed on a front side of the first housing part, the second housing part, and the third housing part. The method may comprise displaying a first execution screen associated with a first application on the flexible display. The method may comprise displaying at least one icon associated with at least one application in a portion of the flexible display. The method may comprise receiving an input to move the at least one icon to a defined portion of the flexible display. The method may comprise, based on receiving the input, displaying a second execution screen associated with the at least one application in the defined portion of the flexible display, and displaying the first execution screen associated with the first application by moving the first execution screen to a left side or a right side of the second execution screen.

For example, the receiving may comprise receiving the input while a state of the housing is corresponding to an unfolded state.

For example, the electronic device may comprise a first sensor configured to detect a first angle between the first housing part and the second housing part, and a second sensor configured to detect a second angle between the second housing part and the third housing part. The method may comprise, in response to detecting the first angle and the second angle which are included in a preset angle range including 180°, determining that the state of the housing is corresponding to the unfolded state.

For example, the housing may comprise a first hinge assembly rotatably coupling the first housing part and the second housing part, and a second hinge assembly rotatably coupling the second housing part and the third housing part. The first portion of the flexible display positioned on the first housing part may be distinguished from a remaining portion of the flexible display by a first foldable portion of the flexible display corresponding to the first hinge assembly. The third portion of the flexible display positioned on the third housing part may be distinguished from a remaining portion of the flexible display by a second foldable portion of the flexible display corresponding to the second hinge assembly.

For example, the receiving may comprise receiving the input associated with the second execution screen of a software application included in a preset category.

For example, the method may comprise, based on receiving another input associated with a third execution screen of a software application of another category different from the preset category, displaying the second execution screen in one portion among the first portion and the third portion. The method may comprise displaying the first execution screen in an entire remaining portion different from the portion among the first portion and the third portion where the second execution screen is displayed.

For example, the receiving may comprise receiving the input in a landscape mode defined by an orientation of the electronic device.

For example, the method may comprise, while displaying, together with the first execution screen, the second execution screen occupying at least two portions among the first portion, the second portion, and the third portion, checking whether a mode of the electronic device switches from the landscape mode to a portrait mode. The method may comprise, based on switching of the mode of the electronic device to the portrait mode, displaying the first execution screen and the second execution screen with equivalent sizes.

As described above, in an example embodiment, a non-transitory computer-readable storage medium storing instructions may be provided. The instructions may be executed by an electronic device comprising a multi-foldable housing including a first housing part, a first hinge assembly, a second housing part rotatably coupled to the first housing part through the first hinge assembly, a second hinge assembly, and a third housing part rotatably coupled to the second housing part through the second hinge assembly, and a flexible display disposed on front sides of the first housing part, the second housing part, and the third housing part. The instructions, when executed by the electronic device, may cause the electronic device to display a first execution screen in an entire displaying region of the flexible display in an unfolded state of the multi-foldable housing. The instructions, when executed by the electronic device, may cause the electronic device to receive an input for further displaying a second execution screen in the displaying region. The instructions, when executed by the electronic device, may cause the electronic device to, in response to the input received while displaying the first execution screen of a first category, display the second execution screen in a first portion of the displaying region positioned on the first housing part and a second portion of the displaying region positioned on the second housing part. The instructions, when executed by the electronic device, may cause the electronic device to display the first execution screen in a third portion of the displaying region that is defined by a foldable portion of the displaying region corresponding to the second hinge assembly and is positioned on the third housing part. The instructions, when executed by the electronic device, may cause the electronic device to, in response to the input received while displaying the first execution screen of a second category, display the first execution screen in the second portion and the third portion which are defined by a foldable portion of the displaying region corresponding to the first hinge assembly. The instructions, when executed by the electronic device, may cause the electronic device to display the second execution screen in the first portion.

For example, the electronic device may comprise a first sensor configured to detect a first angle between the first housing part and the second housing part, and a second sensor configured to detect a second angle between the second housing part and the third housing part. The instructions, when executed by the electronic device, may cause the electronic device to, in response to detecting the first angle and the second angle which are included in the preset angle range including 180°, detect the unfolded state of the multi-foldable housing.

For example, a category of the first execution screen including the first category and the second category may be set by a resource of a software application executed to provide the first execution screen.

For example, the instructions, when executed by the electronic device, may cause the electronic device to identify a category corresponding to a software application providing the first execution screen from among the first category and the second category using white-list information.

As described above, according to an example embodiment, an electronic device (e.g., the electronic device 100 of FIG. 5) may comprise a multi-foldable housing including a first housing part (e.g., the first housing part 110 of FIG. 4A and/or FIG. 4B), a first hinge assembly (e.g., the first hinge assembly 150 of FIG. 4A and/or FIG. 4B), a second housing part (e.g., the second housing part 120 of FIG. 4A and/or FIG. 4B) rotatably coupled to the first housing part through the first hinge assembly, a second hinge assembly (e.g., the second hinge assembly 160 of FIG. 4A and/or FIG. 4B), and a third housing part (e.g., the third housing part 130 of FIG. 4A and/or FIG. 4B) rotatably coupled to the second housing part through the second hinge assembly, a flexible display (e.g., the flexible display 140 of FIG. 4A and/or FIG. 4B) disposed on front sides of the first housing part, the second housing part, and the third housing part, memory (e.g., the memory 520 of FIG. 5), comprising one or more storage mediums, storing instructions, and at least one processor (e.g., the processor 510 of FIG. 5) comprising processing circuitry. The instructions, when executed by the at least one processor individually and/or collectively, may cause the electronic device to display a first execution screen in an entire displaying region of the flexible display in an unfolded state of the multi-foldable housing. The instructions, when executed by the at least one processor individually and/or collectively, may cause the electronic device to receive an input for further displaying a second execution screen in the displaying region. The instructions, when executed by the at least one processor individually and/or collectively, may cause the electronic device to, in response to the input received while displaying the first execution screen of a first category, display the second execution screen in a first portion (e.g., the first portion r1 of FIG. 4A) of the displaying region positioned on the first housing part and a second portion (e.g., the second portion r2 of FIG. 4A) of the displaying region positioned on the second housing part. The instructions, when executed by the at least one processor individually and/or collectively, may cause the electronic device to display the first execution screen in a third portion (e.g., the third portion r3 of FIG. 4A) of the displaying region that is defined by a foldable portion of the displaying region corresponding to the second hinge assembly and is positioned on the third housing part. The instructions, when executed by the at least one processor individually and/or collectively, may cause the electronic device to, in response to the input received while displaying the first execution screen of a second category, display the first execution screen in the second portion and the third portion which are defined by a foldable portion of the displaying region corresponding to the first hinge assembly. The instructions, when executed by the at least one processor individually and/or collectively, may cause the electronic device to display the second execution screen in the first portion.

For example, a category of the first execution screen including the first category and the second category may be set by a resource of a software application executed to provide the first execution screen.

For example, the instructions, when executed by the at least one processor individually and/or collectively, may cause the electronic device to identify a category corresponding to a software application providing the first execution screen from among the first category and the second category using white-list information.

The device described above may be implemented as a hardware component, a software component, and/or a combination of a hardware component and a software component. For example, the devices and components described in the various embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to various embodiments may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various embodiments have been described above with reference to various examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the disclosure.

It will also be understood that any of the embodiment(s) described herein may be used in conjunction with any other embodiment(s) describe herein.

No claim element is to be construed under the provisions of 35 U.S.C. § 112, sixth paragraph, unless the element is expressly recited using the phrase “means for“ or ”means.”

What is claimed is:

1. An electronic device comprising:
a housing includes a first housing, a second housing rotatably coupled to the first housing, and a third housing rotatably coupled to the second housing;
a flexible display disposed on a front side of the first housing, the second housing, and the third housing;
memory, comprising one or more storage mediums, storing instructions; and
at least one processor comprising processing circuitry,
wherein the instructions, when executed by at least one processor, individually or in any combination, cause the electronic device to:
display a first execution screen associated with a first application on the flexible display;
display at least one icon associated with at least one application in a portion of the flexible display;
receive an input to move the at least one icon to a defined portion of the flexible display; and
based on receiving the input, display a second execution screen associated with the at least one application in the defined portion of the flexible display and display the first execution screen associated with the first application by moving to a left side or a right side of the second execution screen.

2. The electronic device of claim 1, wherein the instructions, when executed by at least one processor, individually or in any combination, cause the electronic device to:
display the second execution screen based on receiving the input while a state of the housing corresponds to an unfolded state.

3. The electronic device of claim 2, further comprises:
a first sensor configured to detect a first angle between the first housing and the second housing; and
a second sensor configured to detect a second angle between the second housing and the third housing,
wherein the instructions, when executed by at least one processor, individually or in any combination, cause the electronic device to:
in response to detecting the first angle and the second angle included in a specified angle range including 180°, determine that the state of the housing corresponds to the unfolded state.

4. The electronic device of claim 1, wherein the housing further comprises:
a first hinge assembly comprising a hinge rotatably coupling the first housing and the second housing; and
a second hinge assembly comprising a hinge rotatably coupling the second housing and the third housing,
wherein the defined portion includes a boundary positioned on the second hinge assembly and parallel to a direction to which the second hinge assembly is extended.

5. The electronic device of claim 1, wherein the instructions, when executed by at least one processor, individually or in any combination, cause the electronic device to:
based on receiving the input associated with the second execution screen of a software application included in a specified category, display the second execution screen occupying at least two portions among a first portion of the flexible display positioned on the first housing, a second portion of the flexible display positioned on the second housing, and a third portion of the flexible display positioned on the third housing.

6. The electronic device of claim 5, wherein the instructions, when executed by at least one processor, individually or in any combination, cause the electronic device to:
based on receiving another input associated with a third execution screen of a software application of another category different from the specified category, display the second execution screen in one portion among the first portion and the third portion, and
display the first execution screen in an entire remaining portion different from the portion among the first portion and the third portion where the second execution screen is displayed.

7. The electronic device of claim 5, wherein the instructions, when executed by at least one processor, individually or in any combination, cause the electronic device to:
based on receiving the input in a landscape mode defined by an orientation of the electronic device, display the second execution screen occupying at least two portions among the first portion, the second portion, and the third portion.

8. The electronic device of claim 7, wherein the instructions, when executed by at least one processor, individually or in any combination, cause the electronic device to:
while displaying, together with the first execution screen, the second execution screen occupying at least two portions among the first portion, the second portion, and the third potion, determine whether a mode of the electronic device changes from the landscape mode to a portrait mode; and
based on changing of the mode of the electronic device to the portrait mode, display the first execution screen and the second execution screen with equivalent sizes.

9. A method of operating an electronic device, wherein the electronic device comprises a housing includes a first housing, a second housing rotatably coupled to the first housing, and a third housing rotatably coupled to the second housing, and a flexible display disposed on a front side of the first housing, the second housing, and the third housing, comprising:
displaying a first execution screen associated with a first application on the flexible display;
displaying at least one icon associated with at least one application in a portion of the flexible display;
receiving an input to move the at least one icon to a defined portion of the flexible display; and
based on receiving the input, displaying a second execution screen associated with the at least one application in the defined portion of the flexible display and displaying the first execution screen associated with the first application by moving to a left side or a right side of the second execution screen.

10. The method of claim 9, wherein the receiving comprises:
receiving the input while a state of the housing corresponds to an unfolded state.

11. The method of claim 10, wherein the electronic device further comprises:
a first sensor configured to detect a first angle between the first housing and the second housing; and
a second sensor configured to detect a second angle between the second housing and the third housing,
wherein the method further comprises:
in response to detecting the first angle and the second angle included in a specified angle range including 180°, determining that the state of the housing corresponds to the unfolded state.

12. The method of claim 9, wherein the housing further comprises:
a first hinge assembly including a hinge rotatably coupling the first housing and the second housing; and
a second hinge assembly including a hinge rotatably coupling the second housing and the third housing,
wherein the defined portion includes a boundary positioned on the second hinge assembly and parallel to a direction to which the second hinge assembly is extended.

13. The method of claim 9, wherein the receiving comprises:
receiving the input associated with the second execution screen of a software application included in a specified category.

14. The method of claim 13, further comprises:
based on receiving another input associated with a third execution screen of a software application of another category different from the specified category, displaying the second execution screen in one portion among a first portion of the flexible display positioned on the first housing and a third portion of the flexible display positioned on the third housing, and
displaying the first execution screen in an entire remaining portion different from the portion among the first portion and the third potion where the second execution screen is displayed.

15. The method of claim 9, wherein the receiving comprises:
receiving the input in a landscape mode defined by an orientation of the electronic device.

16. The method of claim 15, further comprises:
while displaying, together with the first execution screen, the second execution screen occupying at least two portions among a first portion of the flexible display positioned on the first housing, a second portion of the flexible display positioned on the second housing, and a third potion of the flexible display positioned on the third housing, determining whether a mode of the electronic device changes from the landscape mode to a portrait mode;
based on changing of the mode of the electronic device to the portrait mode, displaying the first execution screen and the second execution screen with equivalent sizes.

17. A non-transitory computer-readable storage medium comprising instructions, wherein the instructions, when executed by at least one processor, comprising processing circuitry, individually or in any combination, of an electronic device comprising a multi-foldable housing includes a first housing, a first hinge assembly, a second housing rotatably coupled to the first housing, through the first hinge assembly, a second hinge assembly, a third housing rotatably coupled to the second housing, through the second hinge assembly, and a flexible display disposed on front sides of the first housing, the second housing, and the third housing, cause the electronic device to:
in an unfolded state of the multi-foldable housing, display a first execution screen in entire displaying region of the flexible display;
receive an input to further display a second execution screen in the displaying region;
in response to the input received while displaying the first execution screen associated with a first category:
display the second execution screen in a first portion of the displaying region positioned on the first housing and a second portion of the displaying region positioned on the second housing; and
display the first execution screen in a third portion of the displaying region positioned on the third housing and defined by a foldable portion of the displaying region corresponding to the second hinge assembly,
in response to the input received while displaying the first execution screen of associated with a second category:
display the first execution screen in the second potion and the third portion defined by a foldable portion of the displaying region corresponding to the first hinge assembly; and
display the second execution screen in the first portion.

18. The non-transitory computer-readable storage medium of claim 17, wherein the electronic device further comprises:
a first sensor configured to detect a first angle between the first housing and the second housing; and
a second sensor configured to detect a second angle between the second housing and the third housing,
wherein the instructions, when executed by at least one processor, individually or in any combination, of the electronic device, cause the electronic device to:
in response to detecting the first angle and the second angle included in a specified angle range including 180°, determine that the state of the housing is corresponding to the unfolded state.

19. The non-transitory computer-readable storage medium of claim 17, wherein a category of the first execution screen including the first category and the second category is set by a resource of a software application executed to provide the first execution screen.

20. The non-transitory computer-readable storage medium of claim 17, wherein the instructions, when executed by at least one processor, individually or in any combination, the electronic device, cause the electronic device to:
identify a category corresponding to a software application providing the first execution screen from among the first category and the second category using white-list information.
